(19) United States
(12) Patent Application Publication
(10) Pub. No.: US 2026/0180254 A1
(43) Pub. Date: Jun. 25, 2026

(54) ELECTRICAL CONNECTOR AND CONNECTOR ASSEMBLY WITH GROUND TERMINAL ELECTRICALLY CONNECTED TO CONDUCTIVE MOUNTING BLOCK

(71) Applicant: DONGGUAN LUXSHARE TECHNOLOGIES CO., LTD, Dongguan City (CN)

(72) Inventors: Bin HUANG, Dongguan City (CN); Tengfang Xiong, Dongguan City (CN); Kunlin YAO, Dongguan City (CN); Jie ZHANG, Dongguan City (CN); Hongji CHEN, Dongguan City (CN); Chenhui ZENG, Dongguan City (CN); Shuangfeng YUAN, Dongguan City (CN)

(73) Assignee: DONGGUAN LUXSHARE TECHNOLOGIES CO., LTD, Dongguan City (CN)

(21) Appl. No.: 19/034,360

(22) Filed: Jan. 22, 2025

(30) Foreign Application Priority Data
Dec. 23, 2024 (CN) 202411911300.5

(51) Int. Cl. H01R 13/652; H01R 12/72; H01R 12/73; H01R 13/24; H01R 13/502; H01R 13/639; H01R 13/6581

(52) U.S. Cl. CPC H01R 13/652; H01R 12/721; H01R 12/73; H01R 13/24; H01R 13/502; H01R 13/6581; H01R 13/639

(57) ABSTRACT

An electrical connector includes a first conductive body, a first terminal module and a conductive mounting block. The first terminal module includes a first signal terminal, a second signal terminal, a first ground terminal and a second ground terminal. The first signal terminal includes a first mounting foot. The second signal terminal includes a second mounting foot. The first ground terminal includes a first tail portion. The second ground terminal includes a second tail portion. The conductive mounting block includes a first shielding rib, a second shielding rib and a first hollow hole. At least one of the first tail portion of the first ground terminal and the second tail portion of the second ground terminal is electrically connected to the conductive mounting block. A connector assembly having the electrical connector is also disclosed.

### CROSS-REFERENCE TO RELATED APPLICATION

This patent application claims priority of a Chinese Patent Application No. 202411911300.5, filed on Dec. 23, 2024 and titled “ELECTRICAL CONNECTOR AND CONNECTOR ASSEMBLY”, the entire content of which is incorporated herein by reference.

### TECHNICAL FIELD

The present disclosure relates to an electrical connector and a connector assembly, which belong to the technical field of connectors.

### BACKGROUND

A connector assembly in the related art includes an electrical connector and a circuit board to which the electrical connector is mounted. The electrical connector usually includes an insulating body and a plurality of conductive terminals mounted to the insulating body. The insulating body defines a mating slot. The conductive terminals include a first signal terminal and a second signal terminal. Each conductive terminal includes a contact arm having a contact portion protruding into the mating slot.

In order to improve shielding, a technical solution is proposed in the related art to replace the insulating body with a conductive body. However, as the requirements for signal transmission of electrical connectors continue to increase, there is still room for improvement on how to improve the signal integrity of the first signal terminal and the second signal terminal during signal transmission.

### SUMMARY

An object of the present disclosure is to provide an electrical connector and a connector assembly that are beneficial to improving signal transmission quality.

In order to achieve the above object, the present disclosure adopts the following technical solution: an electrical connector, including: a first conductive body, the first conductive body defining a first receiving slot extending along a first direction; a first terminal module, the first terminal module being at least partially mounted to the first conductive body; the first terminal module including a plurality of first conductive terminals; the plurality of first conductive terminals including a first signal terminal, a second signal terminal, a first ground terminal located on one side of the first signal terminal and the second signal terminal, and a second ground terminal located on another side of the first signal terminal and the second signal terminal; each of the first signal terminal and the second signal terminal including a first contact arm; the first contact arm including a first contact portion protruding into the first receiving slot; neither the first signal terminal nor the second signal terminal being in contact with the first conductive body; the first signal terminal further including a first mounting foot configured to be mounted to a circuit board; the second signal terminal further including a second mounting foot configured to be mounted to the circuit board; the first ground terminal including a first tail portion; the second ground terminal including a second tail portion; and a conductive mounting block mounted to the first terminal module; the conductive mounting block including a first shielding rib, a second shielding rib and a first hollow hole; at least one of the first tail portion of the first ground terminal and the second tail portion of the second ground terminal being electrically connected to the conductive mounting block; both the first mounting foot of the first signal terminal and the second mounting foot of the second signal terminal passing through the first hollow hole to be located between the first shielding rib and the second shielding rib; the first shielding rib and the second shielding rib being configured to be mounted to the circuit board.

In order to achieve the above object, the present disclosure adopts the following technical solution: a connector assembly, including: an electrical connector, the electrical connector including: a first conductive body defining a first receiving slot extending along a first direction; a first terminal module being at least partially mounted to the first conductive body; the first terminal module including a plurality of first conductive terminals; the plurality of first conductive terminals including a first signal terminal, a second signal terminal, a first ground terminal located on one side of the first signal terminal and the second signal terminal, and a second ground terminal located on another side of the first signal terminal and the second signal terminal; each of the first signal terminal and the second signal terminal including a first contact arm; the first contact arm including a first contact portion protruding into the first receiving slot; neither the first signal terminal nor the second signal terminal being in contact with the first conductive body; the first signal terminal further including a first mounting foot; the second signal terminal further including a second mounting foot; the first ground terminal including a first tail portion; the second ground terminal including a second tail portion; and a conductive mounting block mounted to the first terminal module; the conductive mounting block including a first shielding rib, a second shielding rib and a first hollow hole; at least one of the first tail portion of the first ground terminal and the second tail portion of the second ground terminal being electrically connected to the conductive mounting block; both the first mounting foot of the first signal terminal and the second mounting foot of the second signal terminal passing through the first hollow hole to be located between the first shielding rib and the second shielding rib; and a circuit board including a plurality of first conductive pads, a first ground conductive pad and a second ground conductive pad; the plurality of first conductive pads including a first signal conductive pad and a second signal conductive pad; the first signal conductive pad and the second signal conductive pad forming a first signal conductive pad group; the first ground conductive pad and the second ground conductive pad being located on two sides of the first signal conductive pad group, respectively; a length of the first ground conductive pad along the first direction being greater than a length of the first signal conductive pad along the first direction, and being also greater than a length of the second signal conductive pad along the first direction; a length of the second ground conductive pad along the first direction being greater than the length of the first signal conductive pad along the first direction, and being also greater than the length of the second signal conductive pad along the first direction; wherein the first mounting foot of the first signal terminal is in electrical contact with the first signal conductive pad; the second mounting foot of the second signal terminal is in electrical contact with the second signal conductive pad; the first shielding rib of the conductive mounting block is in electrical contact with the first ground conductive pad; and the second shielding rib of the conductive mounting block is in electrical contact with the second ground conductive pad.

Compared with the prior art, the present disclosure is provided with the first ground terminal located on one side of the first signal terminal and the second signal terminal, and the second ground terminal located on another side of the first signal terminal and the second signal terminal. Therefore, the ground shielding effect on the first signal terminal and the second signal terminal is improved. Besides, the first ground terminal includes the first tail portion, and the second ground terminal includes the second tail portion. At least one of the first tail portion of the first ground terminal and the second tail portion of the second ground terminal is electrically connected to the conductive mounting block. The first mounting foot of the first signal terminal and the second mounting foot of the second signal terminal both pass through the first hollow hole to be located between the first shielding rib and the second shielding rib. The first shielding rib and the second shielding rib are configured to be mounted to the circuit board. With this arrangement, the present disclosure integrates the conductive mounting block with the first ground terminal and/or the second ground terminal, thereby improving the ground shielding effect and improving the quality of signal transmission.

### BRIEF DESCRIPTION OF DRAWINGS

FIG. 1 is a perspective view of a connector assembly in accordance with an embodiment of the present disclosure, in which an electrical connector is mounted on a circuit board;

FIG. 2 is a perspective view of FIG. 1 from another angle;

FIG. 3 is a partially exploded perspective view of FIG. 1, in which the electrical connector and the circuit board are separated from each other;

FIG. 4 is a top view of the circuit board shown in FIG. 3;

FIG. 5 is a partially exploded perspective view of FIG. 3 from another angle;

FIG. 6 is a partial enlarged view of frame part B in FIG. 5;

FIG. 7 is a top view of the electrical connector shown in FIG. 5;

FIG. 8 is a partially exploded perspective view of the electrical connector shown in FIG. 3;

FIG. 9 is a partially exploded perspective view of FIG. 8 from another angle;

FIG. 10 is a further perspective exploded view after removing metal fixing pieces and locking hooks in FIG. 8, in which a conductive mounting block is separated;

FIG. 11 is a top view of the conductive mounting block in FIG. 10;

FIG. 12 is a partially exploded perspective view of FIG. 10 from another angle;

FIG. 13 is a partial enlarged view of frame part C in FIG. 12;

FIG. 14 is a front view of FIG. 10;

FIG. 15 is a further partial perspective exploded view after removing the conductive mounting block in FIG. 10;

FIG. 16 is a partially exploded perspective view of FIG. 15 from another angle;

FIG. 17 is a further partially exploded perspective view of FIG. 15;

FIG. 18 is a partially exploded perspective view of a first module in FIG. 17;

FIG. 19 is a partially exploded perspective view of FIG. 18 from another angle;

FIG. 20 is a partially exploded perspective view of a second module in FIG. 17;

FIG. 21 is a partially exploded perspective view of FIG. 20 from another angle;

FIG. 22 is a partially exploded perspective view of a third module in FIG. 17;

FIG. 23 is a partially exploded perspective view of FIG. 22 from another angle;

FIG. 24 is a partially exploded perspective view of a fourth module in FIG. 17;

FIG. 25 is a partially exploded perspective view of FIG. 24 from another angle;

FIG. 26 is a further exploded perspective view of FIG. 18;

FIG. 27 is an exploded perspective view of FIG. 26 from another angle;

FIG. 28 is a further exploded perspective view of FIG. 20;

FIG. 29 is an exploded perspective view of FIG. 28 from another angle;

FIG. 30 is a further exploded perspective view of FIG. 22;

FIG. 31 is an exploded perspective view of FIG. 30 from another angle;

FIG. 32 is a further exploded perspective view of FIG. 24;

FIG. 33 is an exploded perspective view of FIG. 32 from another angle;

FIG. 34 is a top view of the first module, in which a first insulating fixing block and a first ground plate are separated;

FIG. 35 is a further exploded view of FIG. 34, in which first conductive terminals are further separated;

FIG. 36 is a bottom view of FIG. 35;

FIG. 37 is a top view of the second module, in which a third insulating fixing block and a third ground plate are separated;

FIG. 38 is a further exploded view of FIG. 37, in which second conductive terminals are further separated;

FIG. 39 is a bottom view of FIG. 38;

FIG. 40 is a top view of a third module, in which a fifth insulating fixing block and a fifth ground plate are separated;

FIG. 41 is a further exploded view of FIG. 40, in which third conductive terminals are further separated;

FIG. 42 is a bottom view of FIG. 41;

FIG. 43 is a top view of a fourth module, in which a seventh insulating fixing block and a seventh ground plate are separated;

FIG. 44 is a further exploded view of FIG. 43, in which fourth conductive terminals are further separated;

FIG. 45 is a bottom view of FIG. 44;

FIG. 46 is a schematic cross-sectional view taken along line D-D in FIG. 1;

FIG. 47 is a partial enlarged view of frame part E in FIG. 46;

FIG. 48 is a schematic cross-sectional view taken along line F-F in FIG. 1;

FIG. 49 is a partial perspective exploded view of part of the first module, part of the second module, part of the third module and part of the fourth module in accordance with another embodiment of the present disclosure;

FIG. 50 is a schematic cross-sectional view of FIG. 48 in accordance with another embodiment of the present disclosure;

FIG. 51 is a partial enlarged view of frame portion H in FIG. 48;

FIG. 52 is a partial enlarged view of frame part I in FIG. 50;

FIG. 53 is a partial enlarged view of FIG. 51 in accordance with another embodiment of the present disclosure; and

FIG. 54 is a partial enlarged view of FIG. 52 in accordance with yet another embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

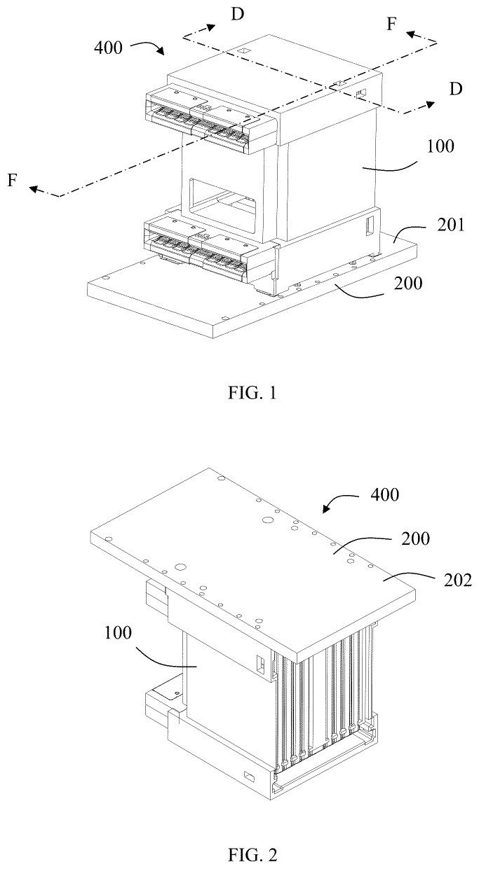

Referring to FIG. 1 to FIG. 5, a first embodiment of the present disclosure discloses a connector assembly 400 including an electrical connector 100 and a circuit board 400 to which the electrical connector 100 is mounted. The electrical connector 100 is used to receive a mating module (not shown) that is at least partially inserted into the electrical connector 100 to achieve electrical conduction. In the illustrated embodiment of the present disclosure, the electrical connector 100 is an OSFP (Octal Small Form-factor Pluggable) receptacle connector. Correspondingly, the mating connector is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating connector is an SFP plug connector, a QSFP plug connector, a QSFP-DD plug connector, an SFP-DD plug connector or a DSFP plug connector, etc. It is understandable to those skilled in the art that the basic structure of the above types of the electrical connectors is regulated by corresponding association standards, and will not be described in detail here. Of course, it is understandable to those skilled in the art that the electrical connector 100 can also be other types of electrical connectors, including but not limited to USB connectors, HDMI connectors, DisplayPort connectors, RJ45 connectors, Thunderbolt connectors, etc.

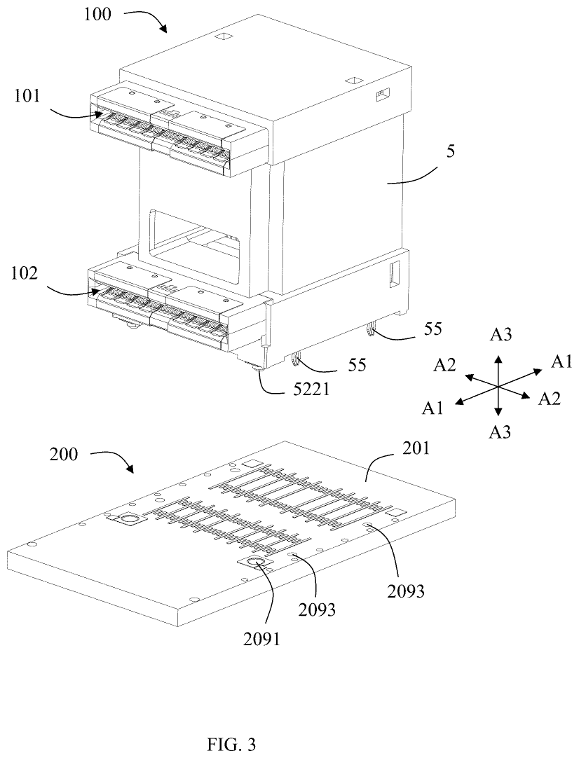

As shown in FIG. 3, in the illustrated embodiment of the present disclosure, the electrical connector 100 is a stacked connector, which defines a first mating slot 101 that at least partially receives a mating module and a second mating slot 102 that at least partially receives another mating module. To simplify the description of the specific embodiments of the present disclosure, an insertion and extraction direction of the mating module and the electrical connector 100 is a first direction A1-A1 (for example, a front-rear direction). A width direction of the first mating slot 101 is a second direction A2-A2 (for example, a left-right direction). An installation direction of the electrical connector 100 and the circuit board 200 is a third direction A3-A3 (for example, a top-bottom direction). Each two of the first direction A1-A1, the second direction A2-A2 and the third direction A3-A3 are perpendicular to each other.

The mating module includes a tongue plate. The tongue plate includes a plurality of first contact pads exposed on an upper surface of the tongue plate and a plurality of second contact pads exposed on a lower surface of the tongue plate. The plurality of first contact pads are disposed at intervals along the second direction A2-A2. The plurality of second contact pads are disposed at intervals along the second direction A2-A2.

Referring to FIG. 3 to FIG. 5, in one embodiment of the present disclosure, the circuit board 200 includes a circuit board upper surface 201, a circuit board lower surface 202, a plurality of first signal conductive areas, and a plurality of second signal conductive areas, a plurality of third signal conductive areas, a plurality of fourth signal conductive areas, a plurality of first ground conductive areas and a plurality of second ground conductive areas.

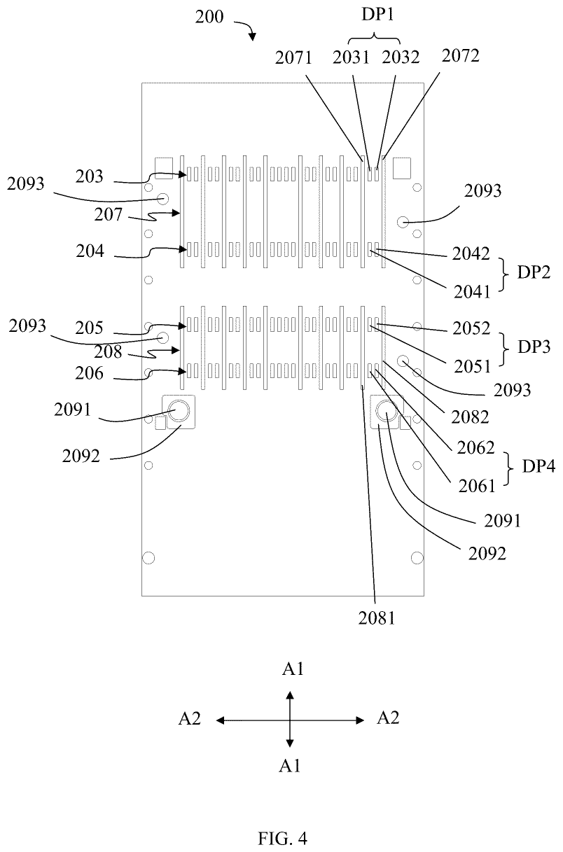

Referring to FIG. 4, in one embodiment of the present disclosure, the plurality of first conductive areas include a plurality of first conductive pads 203. The plurality of second conductive areas include a plurality of second conductive pads 204. The plurality of third conductive areas include a plurality of third conductive pads 205. The plurality of fourth conductive areas include a plurality of fourth conductive pads 206. The plurality of first ground conductive areas include a plurality of first ground conductive components 207. The plurality of second ground conductive areas includes a plurality of second ground conductive components 208. The plurality of first conductive pads 203, the plurality of second conductive pads 204, the plurality of third conductive pads 205, the plurality of fourth conductive pads 206, the plurality of first ground conductive components 207 and the plurality of second ground conductive components 208 are configured to be electrically connected to corresponding conductive terminals of the electrical connector 100 by surface mounted technology (SMT). The plurality of first conductive pads 203 are exposed on the circuit board upper surface 201 and are spaced apart along the second direction A2-A2. The plurality of second conductive pads 204 are exposed on the circuit board upper surface 201 and are spaced apart along the second direction A2-A2. The plurality of third conductive pads 205 are exposed on the circuit board upper surface 201 and are spaced apart along the second direction A2-A2. The plurality of fourth conductive pads 206 are exposed on the circuit board upper surface 201 and are spaced apart along the second direction A2-A2. The plurality of first conductive pads 203, the plurality of second conductive pads 204, the plurality of third conductive pads 205 and the plurality of fourth conductive pads 206 are generally arranged in four rows along the first direction A1-A1.

The plurality of first ground conductive components 207 include a plurality of first ground conductive pads 2071 and a plurality of second ground conductive pads 2072. The plurality of second ground conductive components 208 include a plurality of third ground conductive pads 2081 and a plurality of fourth ground conductive pads 2082.

The plurality of first conductive pads 203 include a plurality of first signal conductive pads 2031 and a plurality of second signal conductive pads 2032. The first signal conductive pad 2031 and the second signal conductive pad 2032, which are disposed adjacent to each other along the second direction A2-A2, form a first signal conductive pad group DP1. In an embodiment of the present disclosure, the first signal conductive pad group DP1 is a differential pair in order to increase the speed of signal transmission. Along the second direction A2-A2, two sides of each first signal conductive pad group DP1 are provided with one first ground conductive pad 2071 and one second ground conductive pad 2072, respectively, so as to improve shielding and improve the quality of signal transmission. In the illustrated embodiment of the present disclosure, a length of each first ground conductive pad 2071 along the first direction A1-A1 is greater than a length of each first signal conductive pad 2031 along the first direction A1-A1, and is also greater than a length of each second signal conductive pad 2032 along the first direction A1-A1, thereby better improving shielding and improving the quality of signal transmission. A length of each second ground conductive pad 2072 along the first direction A1-A1 is greater than the length of each first signal conductive pad 2031 along the first direction A1-A1, and is also greater than the length of each second signal conductive pad 2032 along the first direction A1-A1, thereby better improving shielding and improving the quality of signal transmission.

In the illustrated embodiment of the present disclosure, the plurality of second conductive pads 204 include a plurality of third signal conductive pads 2041 and a plurality of fourth signal conductive pads 2042. The third signal conductive pad 2041 and the fourth signal conductive pad 2042, which are disposed adjacent to each other along the second direction A2-A2, form a second signal conductive pad group DP2. In an embodiment of the present disclosure, the second signal conductive pad group DP2 is a differential pair in order to increase the speed of signal transmission. Along the second direction A2-A2, two sides of each second signal conductive pad group DP2 are provided with one first ground conductive pad 2071 and one second ground conductive pad 2072, respectively, so as to improve shielding and improve the quality of signal transmission. In the illustrated embodiment of the present disclosure, the length of each first ground conductive pad 2071 along the first direction A1-A1 is greater than a length of each third signal conductive pad 2041 along the first direction A1-A1, and is also greater than a length of each fourth signal conductive pad 2042 along the first direction A1-A1, thereby better improving shielding and improving the quality of signal transmission. The length of each second ground conductive pad 2072 along the first direction A1-A1 is greater than the length of each third signal conductive pad 2041 along the first direction A1-A1, and is also greater than the length of each fourth signal conductive pad 2042 along the first direction A1-A1, thereby better improving shielding and improving the quality of signal transmission.

Specifically, in the illustrated embodiment of the present disclosure, the first signal conductive pad group DP1 composed of the first signal conductive pad 2031 and the second signal conductive pad 2032, and the second signal conductive pad group DP2 composed of the third signal conductive pad 2041 and the fourth signal conductive pad 2042 share the first ground conductive pad 2071 and the second ground conductive pad 2072. The first ground conductive pad 2071 and the second ground conductive pad 2072 extend along the first direction A1-A1 beyond ends of the first signal conductive pad 2031 and the second signal conductive pad 2032 that are away from the second signal conductive pad group DP2. And, the first ground conductive pad 2071 and the second ground conductive pad 2072 extend along the first direction A1-A1 beyond ends the third signal conductive pad 2041 and the fourth signal conductive pad 2042 that are away from the first signal conductive pad group DP1. With this arrangement, regardless of the first signal conductive pad group DP1 or the second signal conductive pad group DP2, along the first direction A1-A1, the first ground conductive pad 2071 and the second ground conductive pad 2072 can provide better shielding effect on both sides.

Similarly, as shown in FIG. 4, in the illustrated embodiment of the present disclosure, the plurality of third conductive pads 205 include a plurality of fifth signal conductive pads 2051 and a plurality of sixth signal conductive pads 2052. The fifth signal conductive pad 2051 and the sixth signal conductive pad 2052, which are disposed adjacent to each other along the second direction A2-A2, form a third signal conductive pad group DP3. In an embodiment of the present disclosure, the third signal conductive pad group DP3 is a differential pair in order to increase the speed of signal transmission. Along the second direction A2-A2, two sides of each third signal conductive pad group DP3 are provided with one third ground conductive pad 2081 and one fourth ground conductive pad 2082, respectively, so as to improve shielding and improve the quality of signal transmission. In the illustrated embodiment of the present disclosure, a length of each third ground conductive pad 2081 along the first direction A1-A1 is greater than a length of each fifth signal conductive pad 2051 along the first direction A1-A1, and is also greater than a length of each sixth signal conductive pad 2052 along the first direction A1-A1, thereby better improving shielding and improving the quality of signal transmission. A length of each fourth ground conductive pad 2082 along the first direction A1-A1 is greater than the length of each fifth signal conductive pad 2051 along the first direction A1-A1, and is also greater than the length of each sixth signal conductive pad 2052 along the first direction A1-A1, thereby better improving shielding and improving the quality of signal transmission.

In the illustrated embodiment of the present disclosure, the plurality of fourth conductive pads 206 include a plurality of seventh signal conductive pads 2061 and a plurality of eighth signal conductive pads 2062. The seventh signal conductive pad 2061 and the eighth signal conductive pad 2062, which are disposed adjacent to each other along the second direction A2-A2, form a fourth signal conductive pad group DP4. In an embodiment of the present disclosure, the fourth signal conductive pad group DP4 is a differential pair in order to increase the speed of signal transmission. Along the second direction A2-A2, two sides of each fourth signal conductive pad group DP4 are provided with one third ground conductive pad 2081 and one fourth ground conductive pad 2082, respectively, so as to improve shielding and improve the quality of signal transmission. In the illustrated embodiment of the present disclosure, the length of each third ground conductive pad 2081 along the first direction A1-A1 is greater than a length of each seventh signal conductive pad 2061 along the first direction A1-A1, and is also greater than a length of each eighth signal conductive pad 2062 along the first direction A1-A1, thereby better improving shielding and improving the quality of signal transmission. The length of each fourth ground conductive pad 2082 along the first direction A1-A1 is greater than the length of each seventh signal conductive pad 2061 along the first direction A1-A1, and is also greater than the length of each eighth signal conductive pad 2062 along the first direction A1-A1, thereby better improving shielding and improving the quality of signal transmission.

Specifically, in the illustrated embodiment of the present disclosure, the third signal conductive pad group DP3 composed of the fifth signal conductive pad 2051 and the sixth signal conductive pad 2052, and the fourth signal conductive pad group DP4 composed of the seventh signal conductive pad 2061 and the eighth signal conductive pad 2062 share the third ground conductive pad 2081 and the fourth ground conductive pad 2082. The third ground conductive pad 2081 and the fourth ground conductive pad 2082 extend along the first direction A1-A1 beyond ends of the fifth signal conductive pad 2051 and the sixth signal conductive pad 2052 that are disposed away from the fourth signal conductive pad group DP4. And, the third ground conductive pad 2081 and the fourth ground conductive pad 2082 extend along the first direction A1-A1 beyond ends of the seventh signal conductive pad 2061 and the eighth signal conductive pad 2062 that are disposed away from the third signal conductive pad group DP3. With this arrangement, regardless of the third signal conductive pad group DP3 or the fourth signal conductive pad group DP4, along the first direction A1-A1, the third ground conductive pad 2081 and the fourth ground conductive pad 2082 can provide better shielding effect on both sides.

Referring to FIG. 3 and FIG. 4, in the illustrated embodiment of the present disclosure, the circuit board 200 further includes a plurality of positioning through holes 2091 extending through the circuit board upper surface 201 and the circuit board lower surface 202, a plurality of ground fixing pieces 2092 exposed on the circuit board upper surface 201, and a plurality of locking through holes 2093 extending through the circuit board upper surface 201 and the circuit board lower surface 202. The ground fixing piece 2092 is disposed around the positioning through hole 2091 which is used to position the electrical connector 100. The ground fixing piece 2092 is used to contact the electrical connector 100 to better achieve grounding and/or fixation. In one embodiment of the present disclosure, the ground fixing piece 2092 is fixed to a corresponding part of the electrical connector 100 by soldering or welding, thereby achieving the grounding function while also increasing the bonding force between the electrical connector 100 and the circuit board 200. In one embodiment of the present disclosure, the plurality of ground fixing pieces 2092 are connected as a whole through internal conductive traces of the circuit board 200 to increase the grounding area.

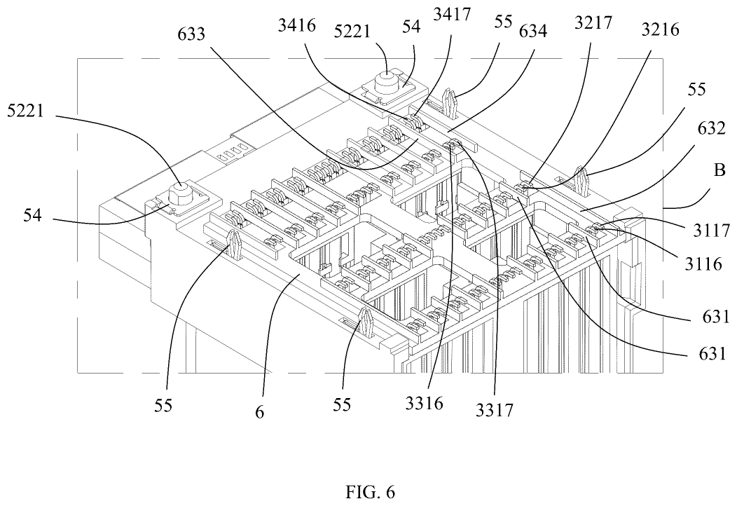

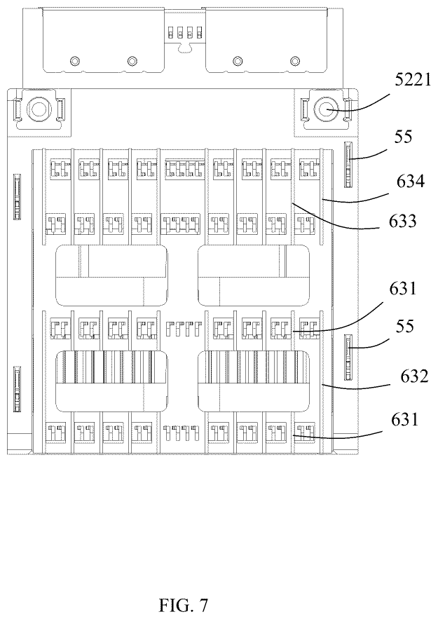

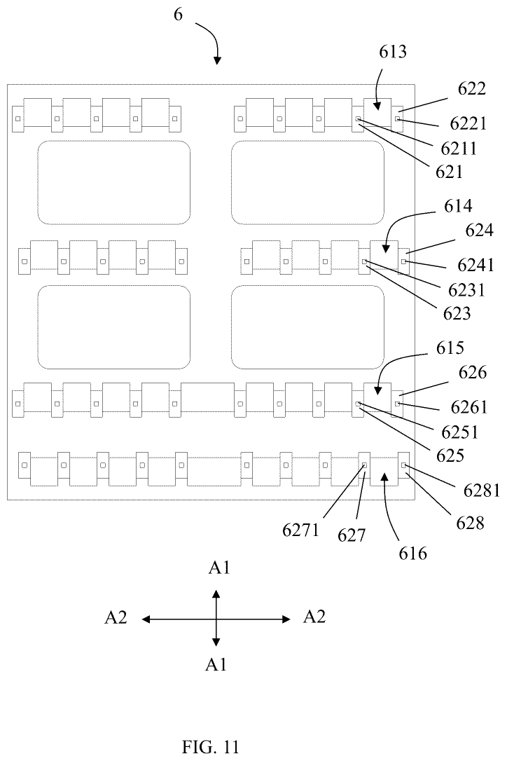

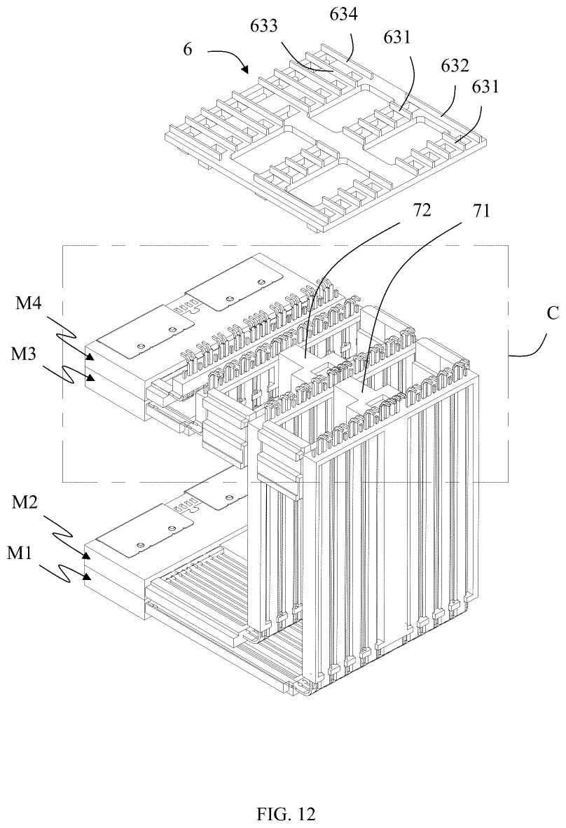

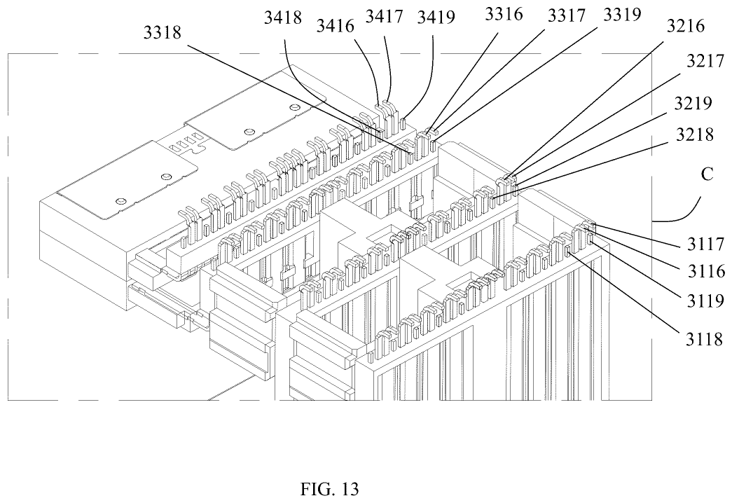

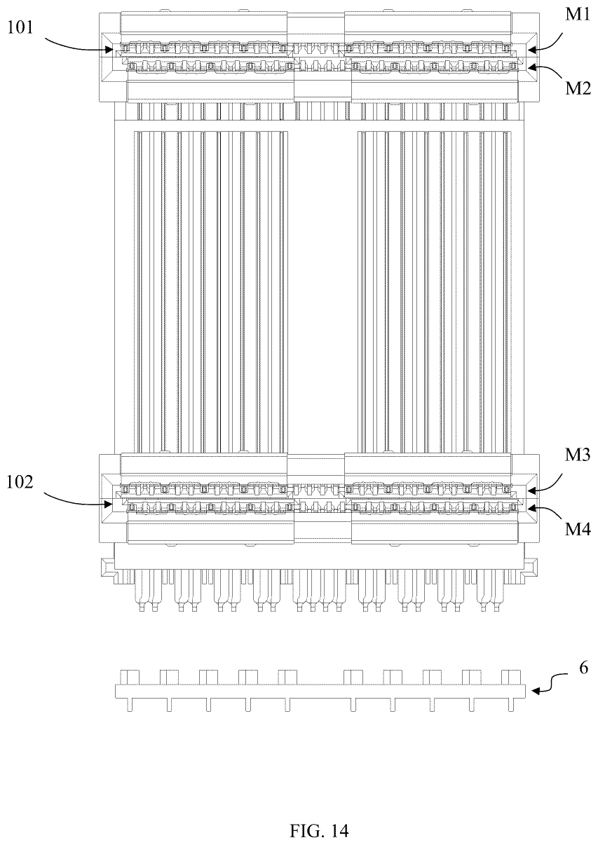

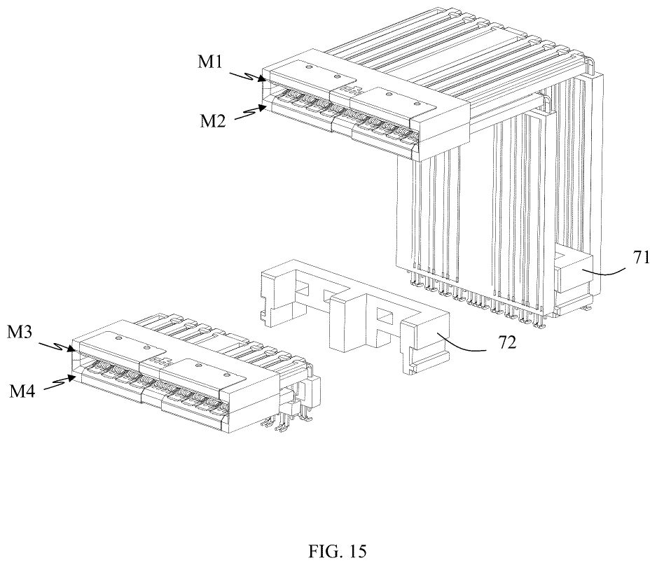

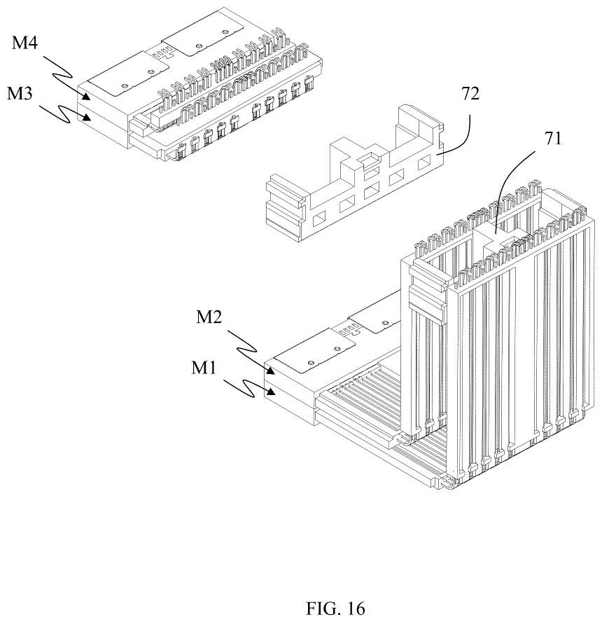

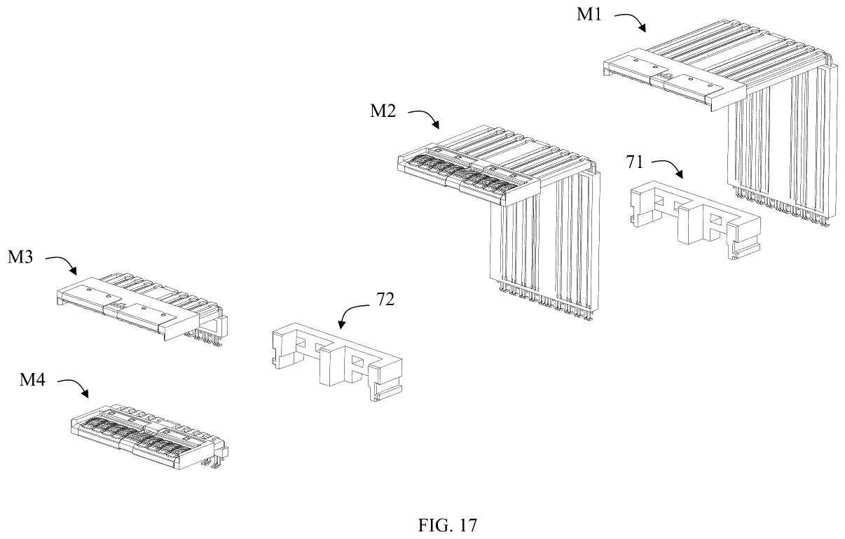

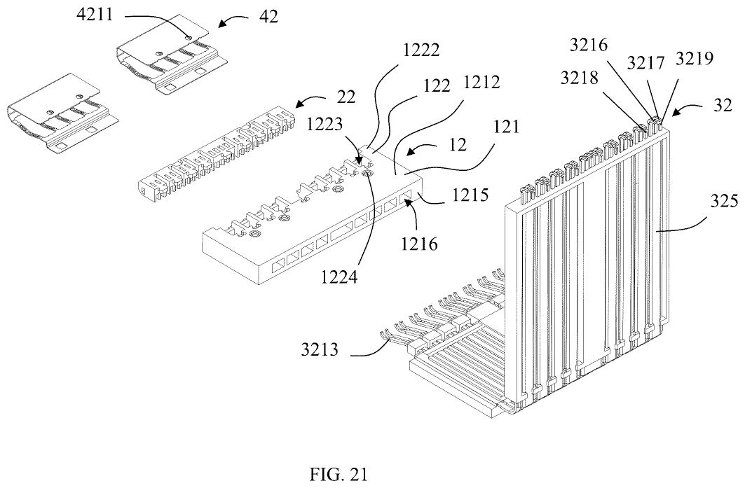

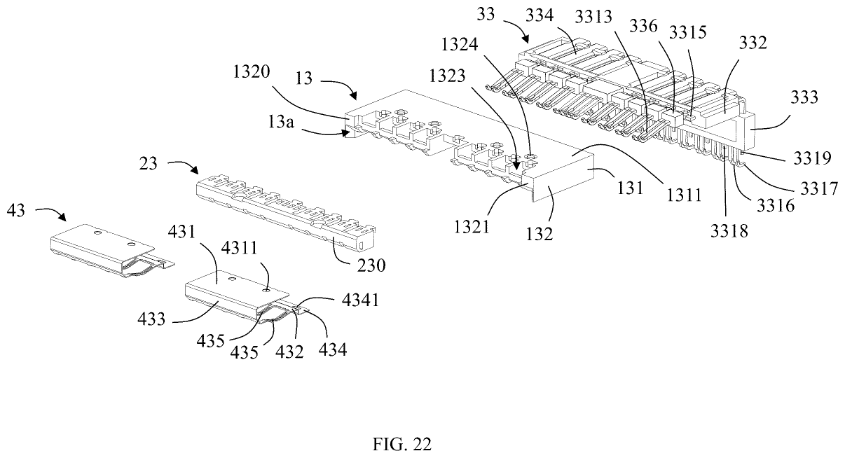

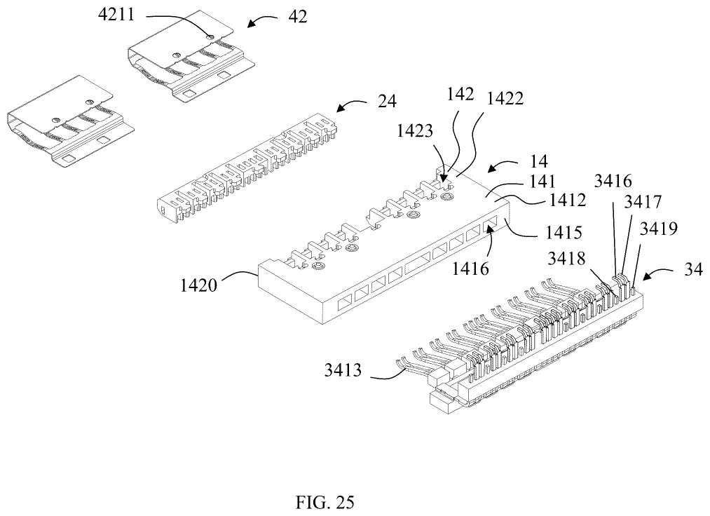

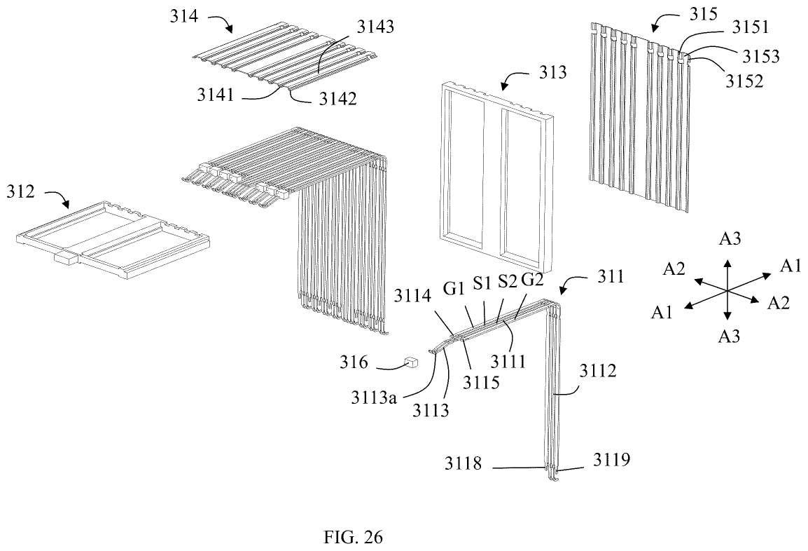

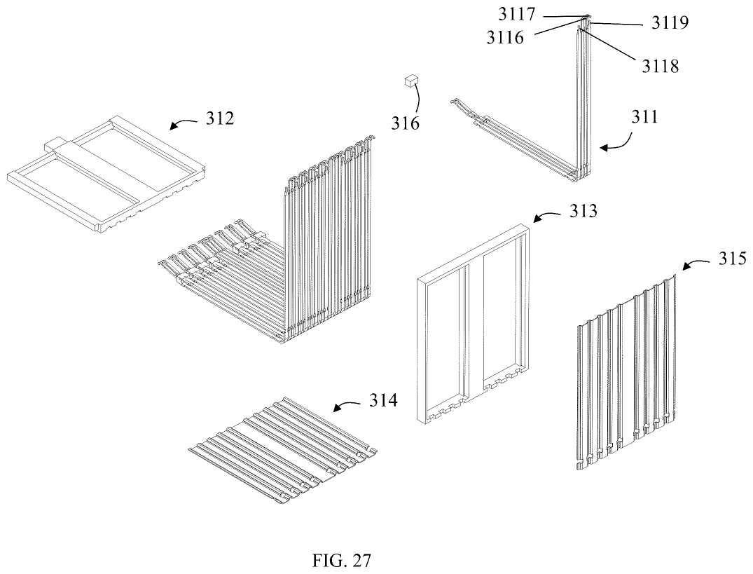

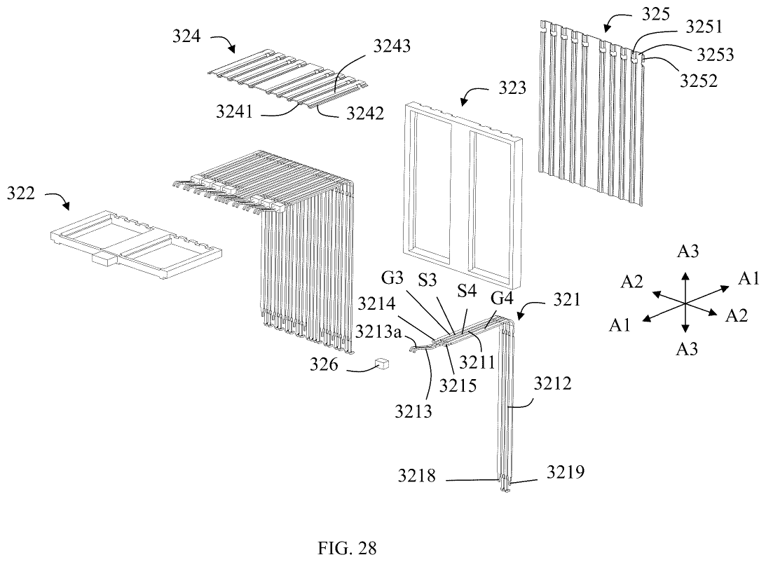

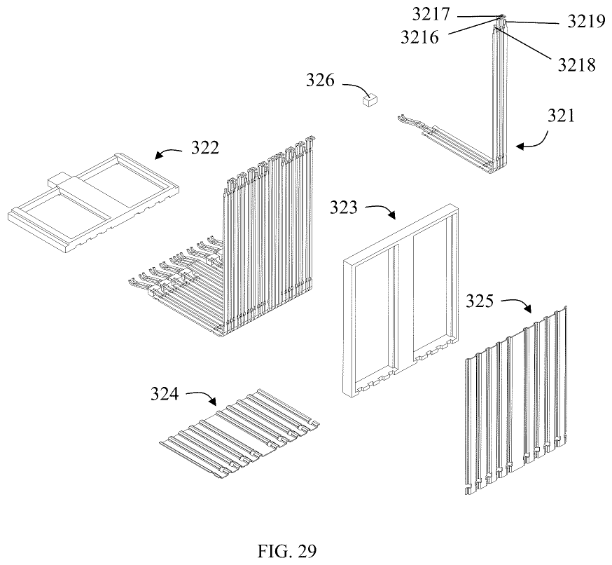

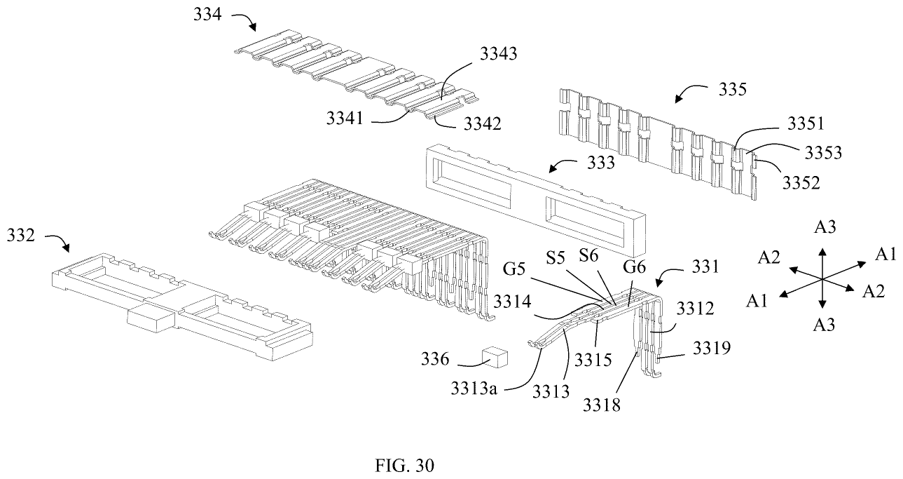

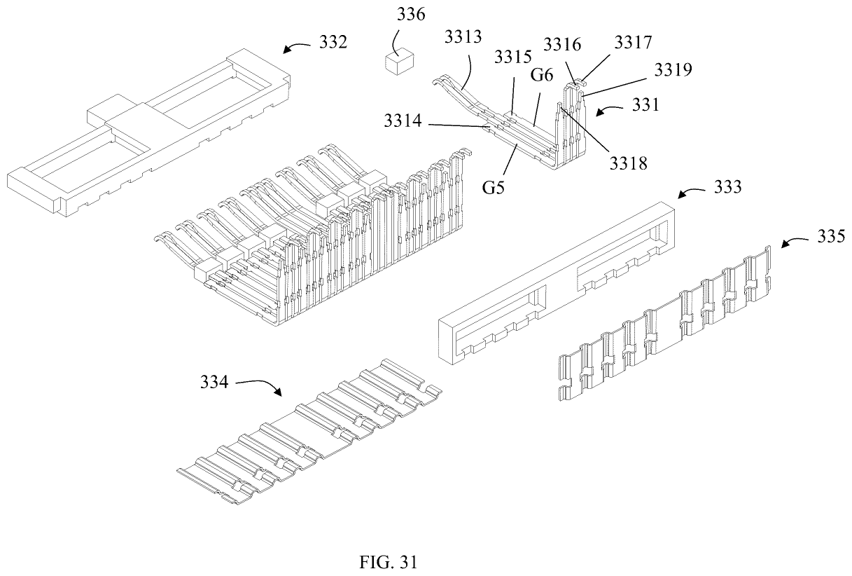

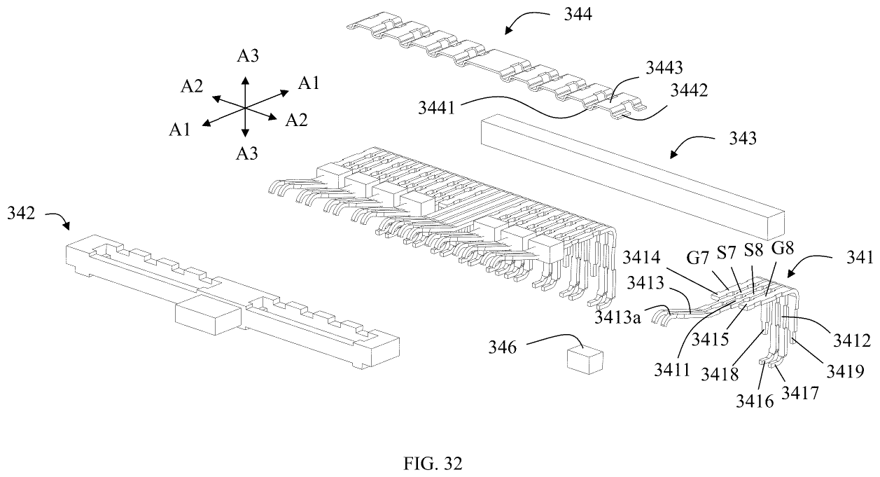

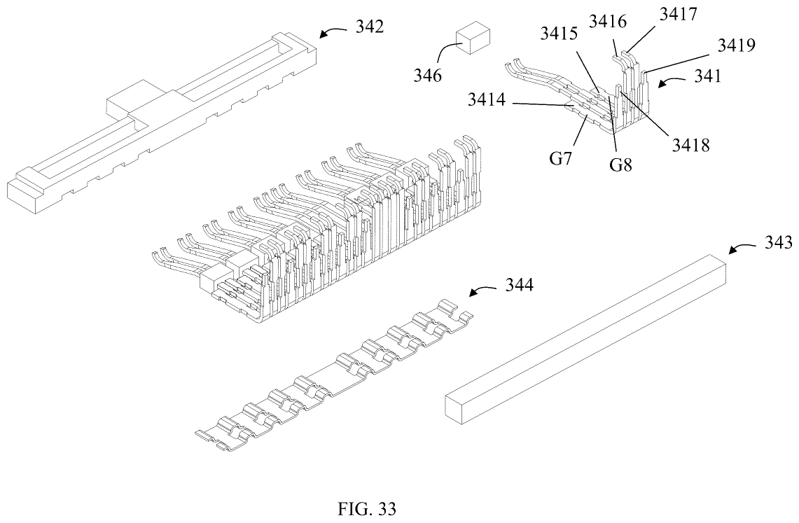

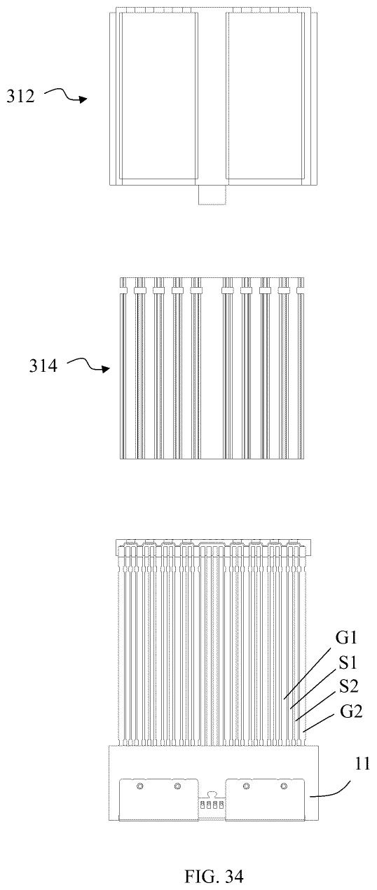

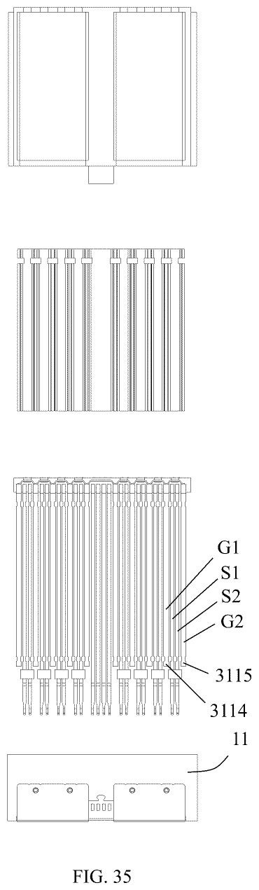

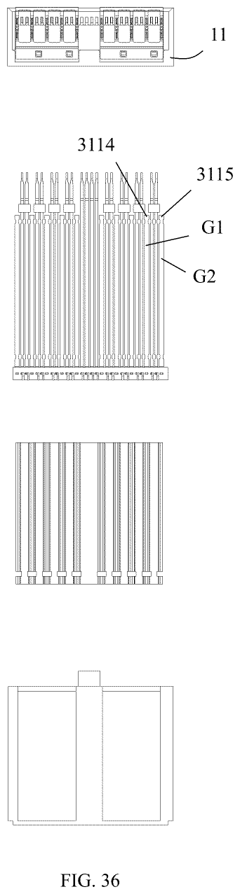

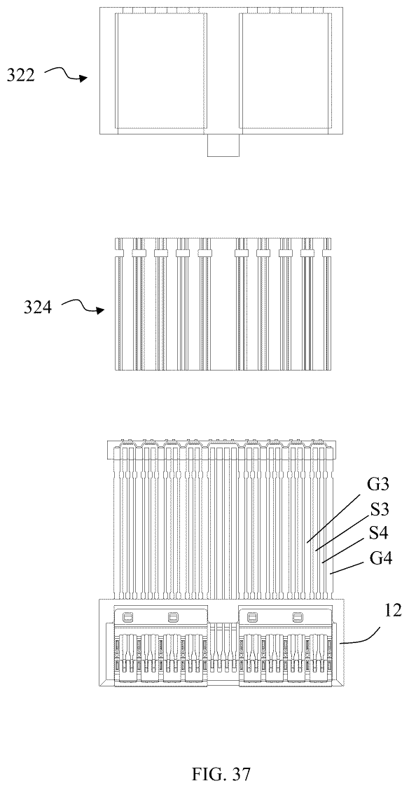

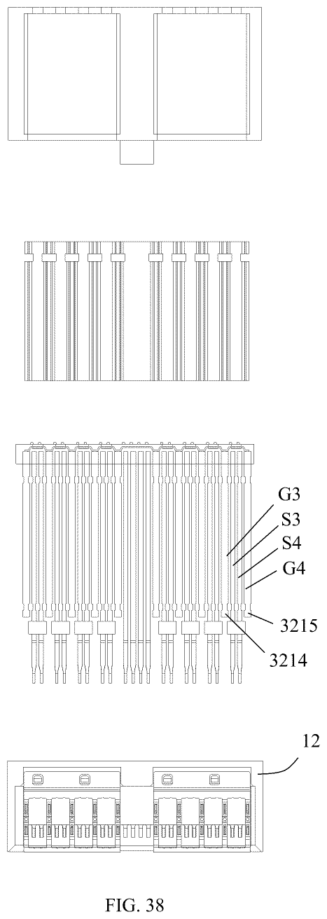

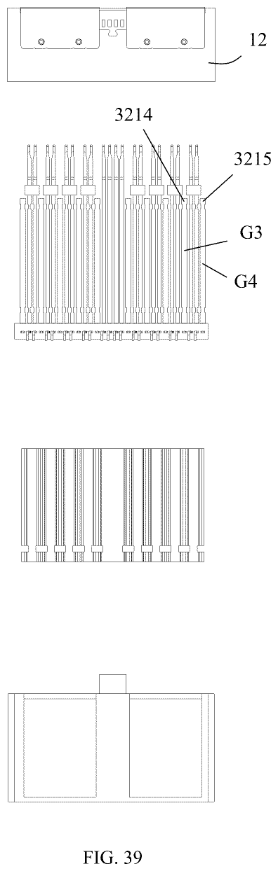

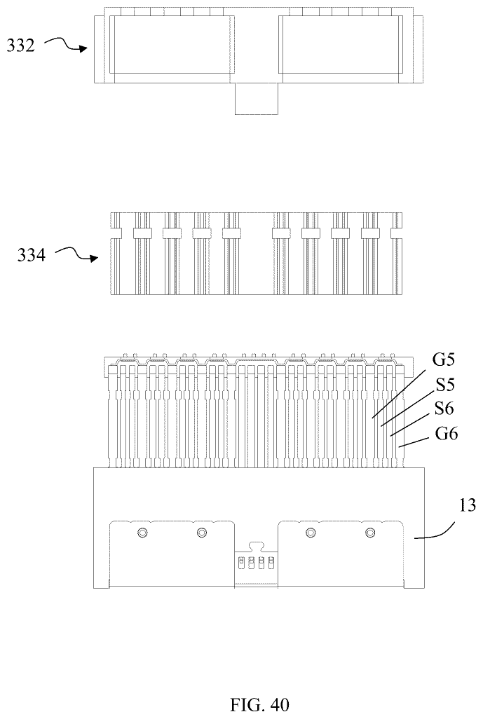

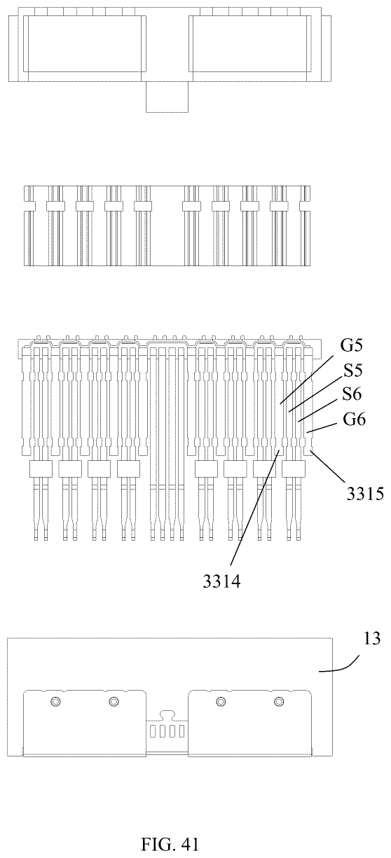

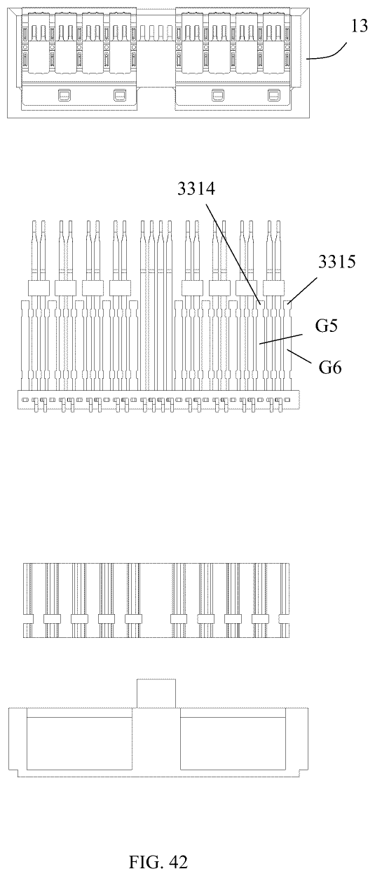

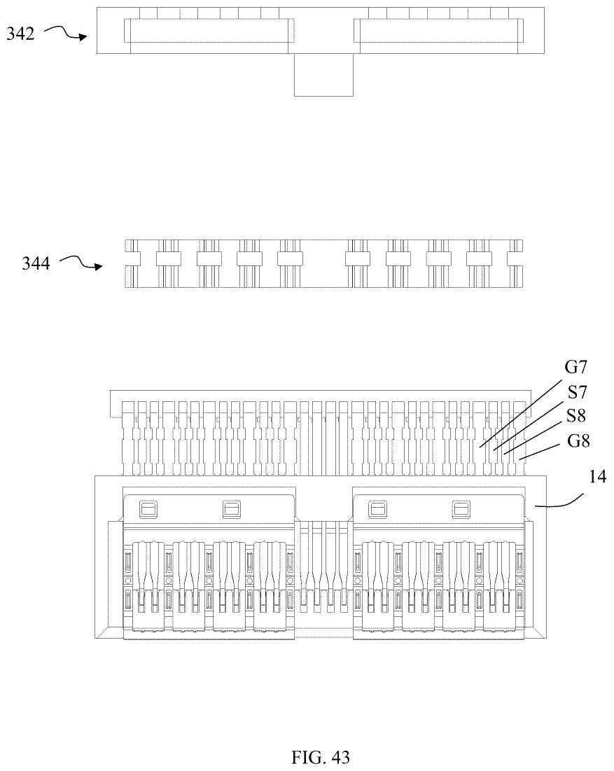

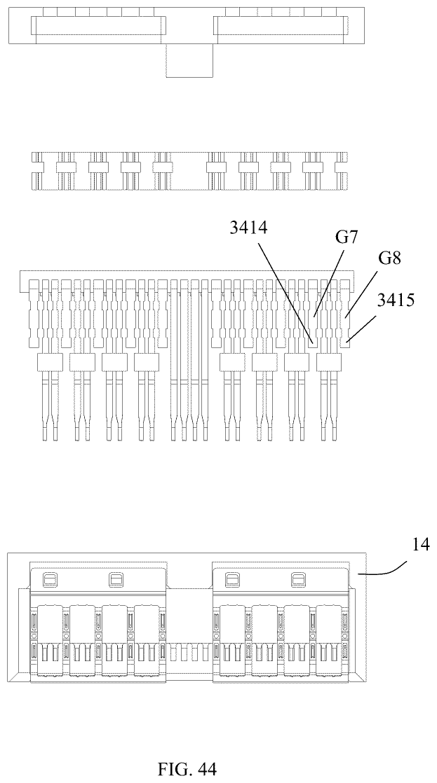

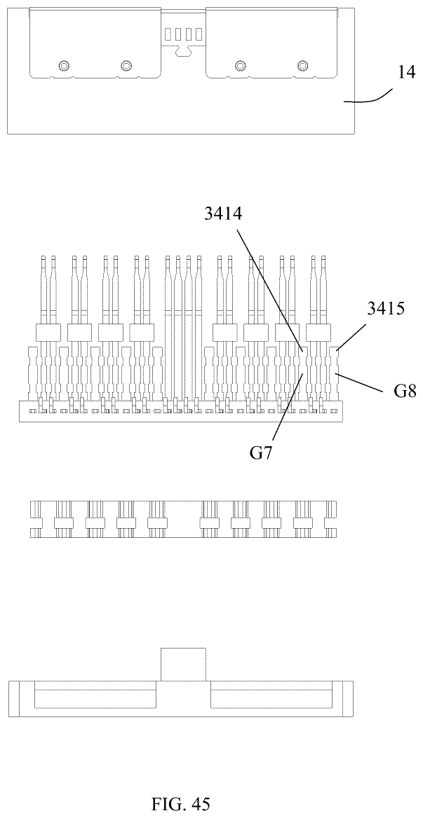

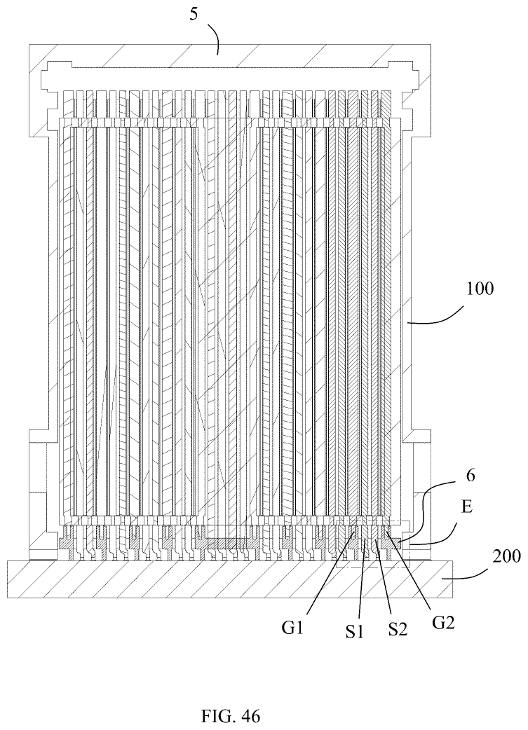

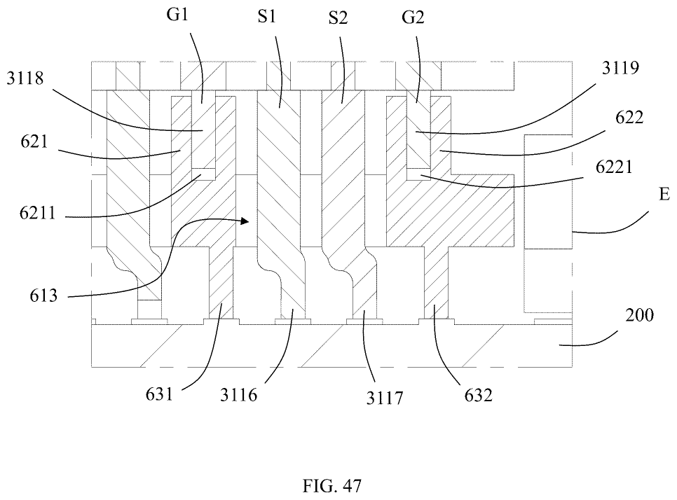

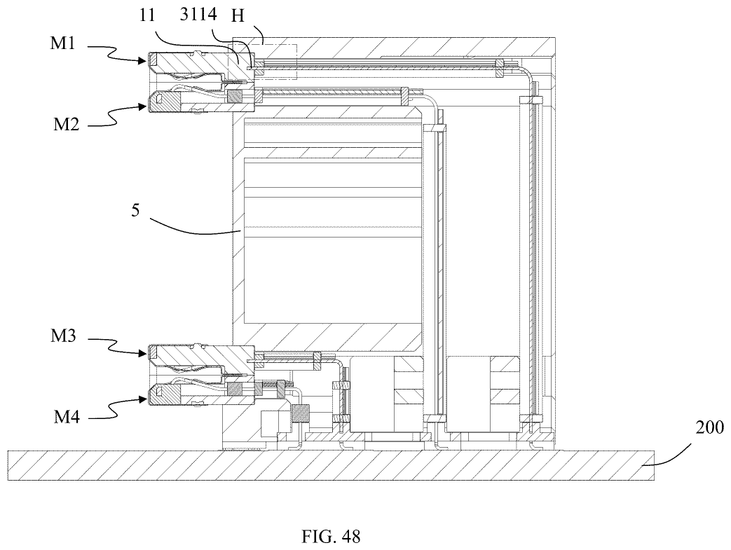

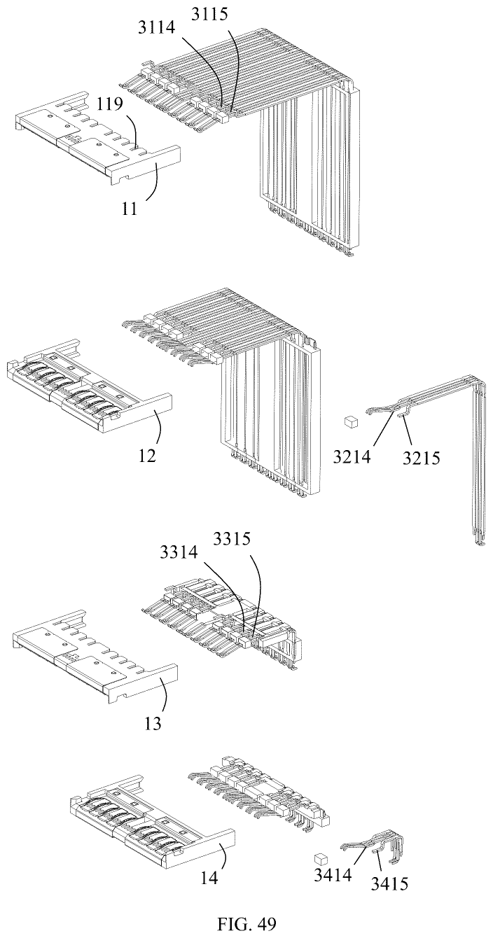

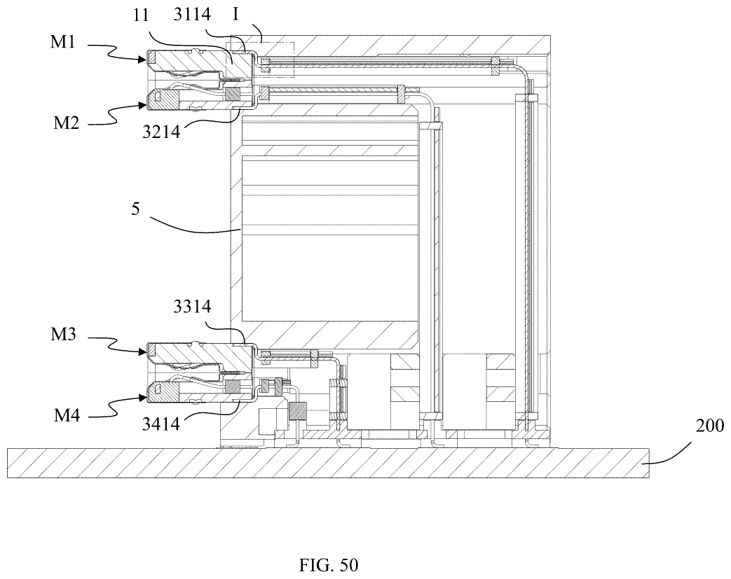

Referring to FIG. 1 to FIG. 54, in one embodiment of the present disclosure, the electrical connector 100 includes an outer insulating housing 5, a first module M1, a second module M2, a third module M3, a fourth module M4 and a conductive mounting block 6. The conductive mounting block 6 is mounted to the first module M1, the second module M2, the third module M3 and the fourth module M4. The first module M1, the second module M2, the third module M3 and the fourth module M4 are all mounted to the outer insulating housing 5.

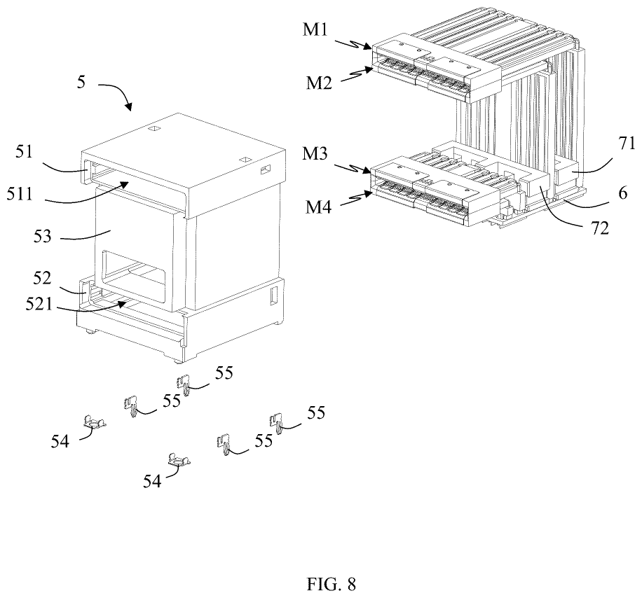

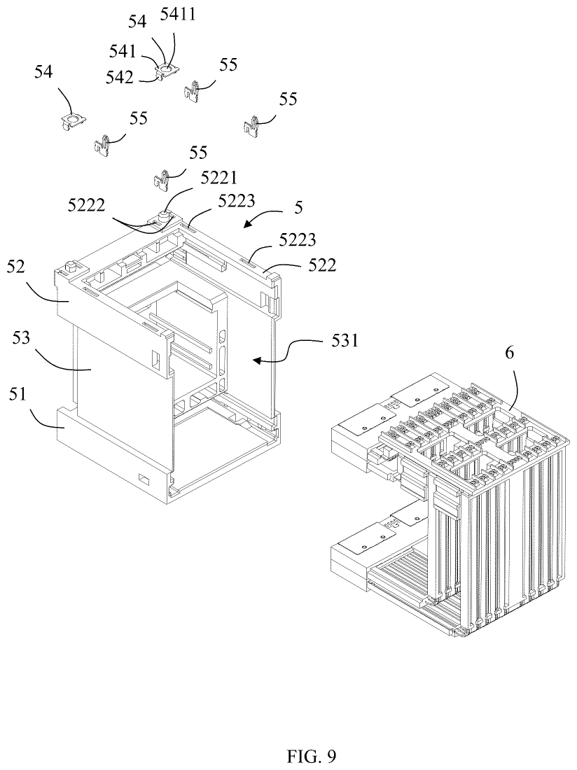

Referring to FIG. 8 and FIG. 9, in the illustrated embodiment of the present disclosure, the outer insulating housing 5 includes a first receiving portion 51, a second receiving portion 52, and an elevated portion 53 connecting the first receiving portion 51 and the second receiving portion 52 and located between the first receiving portion 51 and the second receiving portion 52. The first receiving portion 51 defines a first installation space 511. The second receiving portion 52 defines a second installation space 521. The elevated portion 53 defines a connection space 531 that communicates with the first installation space 511 and the second installation space 521. The first module M1 and the second module M2 are at least partially installed in the first installation space 511. The third module M3 and the fourth module M4 are at least partially installed in the second installation space 521. The first module M1, the second module M2, the third module M3 and the fourth module M4 are all at least partially disposed in the connection space 531.

In the illustrated embodiment of the present disclosure, the second receiving portion 52 includes a mounting wall 522 and a plurality of mounting positioning posts 5221 protruding downwardly beyond the mounting wall 522 along the third direction A3-A3. The mounting wall 522 defines a plurality of mounting slits 5222 located on two sides of each mounting positioning post 5221 and a plurality of fixing grooves 5223 located on two sides of the mounting wall 522.

In the illustrated embodiment of the present disclosure, the electrical connector 100 includes a plurality of metal fixing pieces 54. Each metal fixing piece 54 includes a fixing base portion 541 and a plurality of fixing inserts 542 bent from two sides of the fixing base portion 541. The fixing base portion 541 defines a mounting through hole 5411 through which the mounting positioning post 5221 passes. The fixing insert 542 is inserted into the mounting slit 5222. The mounting positioning post 5221 is used to be inserted into the positioning through hole 2091 to achieve positioning. The fixing base portion 541 is configured to be fixed to the ground fixing piece 2092 by soldering or welding.

Besides, in the illustrated embodiment of the present disclosure, the electrical connector 100 further includes a plurality of locking hooks 55 partially fixed in the fixing grooves 5223. The locking hooks 55 protrude downwardly beyond the mounting wall 522 along the third direction A3-A3. The locking hooks 55 are configured to be inserted into the locking through holes 2093 so as to reliably install the electrical connector 100 on the circuit board 200.

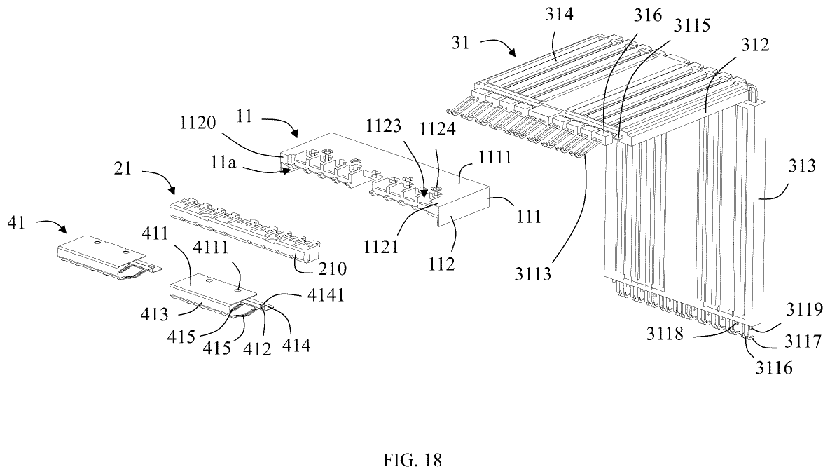

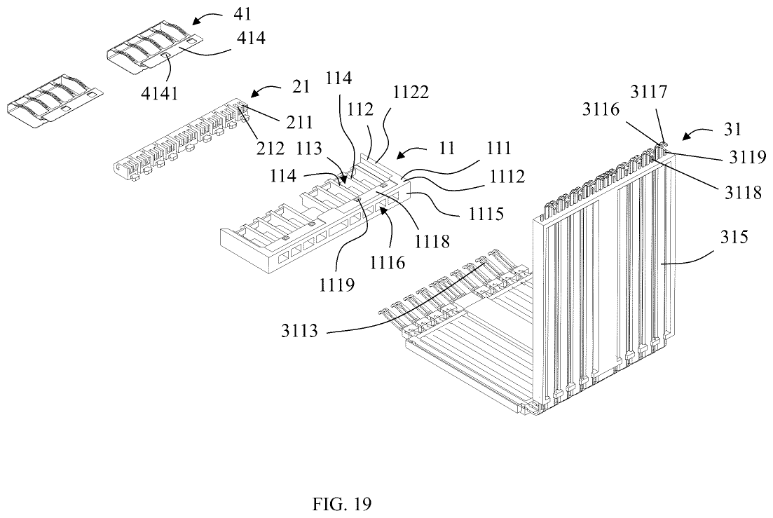

Referring to FIG. 18, FIG. 19 and FIG. 34 to FIG. 36, in the illustrated embodiment of the present disclosure, the first module M1 includes a first conductive body 11, a first insulating block 21 fixed to the first conductive body 11, a first terminal module 31 mounted to the first conductive body 11, and a first ground sheet 41 fixed to the first conductive body 11.

In an embodiment of the present disclosure, the first conductive body 11 is a metal housing made of metal material so as to further improve the shielding effect and improve the quality of signal transmission. In another embodiment of the present disclosure, the first conductive body 11 may also be a composite housing formed by electroplating a metal material on an insulating material. The composite housing can also improve the shielding effect and improve the quality of signal transmission.

In an embodiment of the present disclosure, the first conductive body 11 includes a first base portion 111 and a first protruding portion 112 extending forwardly from the first base portion 111. The first base portion 111 is provided with a first upper surface 1111, a first lower surface 1112 and a first rear surface 1115. A bottom of the first base portion 111 is further provided with at least one first recess 1118 located adjacent to the first protruding portion 112. In the illustrated embodiment of the present disclosure, two first recesses 1118 are provided. The first base portion 111 is further provided with a plurality of first mounting protrusions 1119 protruding into each first recess 1118.

The first protruding portion 112 includes a second upper surface 1121, a second lower surface 1122, and a plurality of first filling grooves 1123 extending upwardly through the second upper surface 1121 along the third direction A3-A3. The first filling grooves 1123 extend forwardly through a first front end surface 1120 of the first protruding portion 112 along the first direction A1-A1. The first protruding portion 112 further includes a plurality of first positioning posts 1124 protruding upwardly beyond the second upper surface 1121 along the third direction A3-A3.

Referring to FIG. 19, in the illustrated embodiment of the present disclosure, the first conductive body 11 further includes a plurality of first terminal module installation slots 113 extending along the first direction A1-A1. Each first terminal module installation slot 113 extends from the first base portion 111 to the first protruding portion 112. A rear end of the first terminal module installation slot 113 extends through the first rear surface 1115 to form a first installation opening 1116. A middle portion of the first terminal module installation slot 113 is circumferentially surrounded by walls of the first conductive body 11. A front end of the first terminal module installation slot 113 extends downwardly through the second lower surface 1122. It is understandable to those skilled in the art that by arranging the middle portion of the first terminal module installation slot 113 to be surrounded by the walls of the first conductive body 11 in a circumferential direction, on the one hand, the conductive terminals located in the first terminal module installation slots 113 can be better shielded; and on the other hand, adjacent first terminal module installation slots 113 can be well separated, thereby reducing signal crosstalk. In addition, the first conductive body 11 further defines a first receiving slot 11a extending along the first direction A1-A1 and extending forwardly through the first protruding portion 112.

The plurality of first terminal module installation slots 113 are spaced apart along the second direction A2-A2. The first conductive housing 11 includes a plurality of first partition walls 114 disposed at intervals along the second direction A2-A2. Two adjacent first terminal module installation slots 113 are separated by a corresponding first partition wall 114 along the second direction A2-A2. In other words, each first terminal module installation slot 113 is surrounded by four walls of the first conductive housing 11 on a length corresponding to the corresponding first partition wall 114, thereby improving the shielding effect. With this arrangement, each first terminal module installation slot 113 is relatively independent, thereby reducing signal crosstalk and improving the quality of data transmission.

The first insulating fixing block 21 is fixed in the first filling grooves 1123. Preferably, in order to increase the bonding force between the first insulating fixing block 21 and the first conductive housing 11, the first insulating fixing block 21 is formed in the first filling grooves 1123. The first insulating fixing block 21 defines a plurality of first slits 211 and a plurality of second slits 212, in which adjacent first slit 211 and second slit 212 form a group and communicate with a corresponding first terminal module installation slot 113. The first insulating fixing block 21 further includes a first front surface 210 which is coplanar with the first front end surface 1120 of the first protruding portion 112.

The first terminal module 31 includes a plurality of first conductive terminals 311, a first insulating fixing block 312 fixed on at least part of the first conductive terminals 311, a second insulating fixing block 313 fixed on at least part of the first conductive terminals 311, a first ground plate 314 installed on the first insulating fixing block 312, and a second ground plate 315 installed on the second insulating fixing block 313.

The plurality of first conductive terminals 311 include a first signal terminal S1, a second signal terminal S2, a first ground terminal G1 located on one side of the first signal terminal S1 and the second signal terminal S2, and a second ground terminal G2 located on another side of the first signal terminal S1 and the second signal terminal S2. Preferably, the first signal terminal S1 and the second signal terminal S2 in each group of first conductive terminals 311 form a differential pair in order to improve signal transmission speed. The first ground terminal G1, the first signal terminal S1, the second signal terminal S2 and the second ground terminal G2 are disposed in sequence along the second direction A2-A2.

In the illustrated embodiment of the present disclosure, each first conductive terminal 311 includes a first fixing portion 3111 and a second fixing portion 3112 bent from the first fixing portion 3111. The first fixing portion 3111 extends along the first direction A1-A1. The second fixing portion 3112 extends along the third direction A3-A3.

Besides, the first signal terminal S1 and the second signal terminal S2 each include a first contact arm 3113 protruding forwardly beyond the first insulating fixing block 312 along the first direction A1-A1. The first contact arm 3113 includes a first contact portion 3113a protruding into the first receiving slot 11a. Neither the first signal terminal S1 nor the second signal terminal S2 is in contact with the first conductive body 11 in order to prevent short circuit. The first ground terminal G1 includes a first abutting portion 3114 protruding beyond the first insulating fixing block 312 along the first direction A1-A1. The second ground terminal G2 includes a second abutting portion 3115 protruding beyond the first insulating fixing block 312. At least one of the first abutting portion 3114 and the second abutting portion 3115 is in contact with the first conductive body 11 to achieve grounding. In the illustrated embodiment of the present disclosure, both the first abutting portion 3114 and the second abutting portion 3115 are in contact with the first conductive body 11 to achieve grounding. The first abutting portion 3114 is in elastic contact or inelastic contact with the first conductive body 11; and/or the second abutting portion 3115 is in elastic contact or inelastic contact with the first conductive body 11. In some embodiments of the present disclosure, the first abutting portion 3114 and the second abutting portion 3115 are both fixed (for example, soldered or welded) to the first conductive body 11.

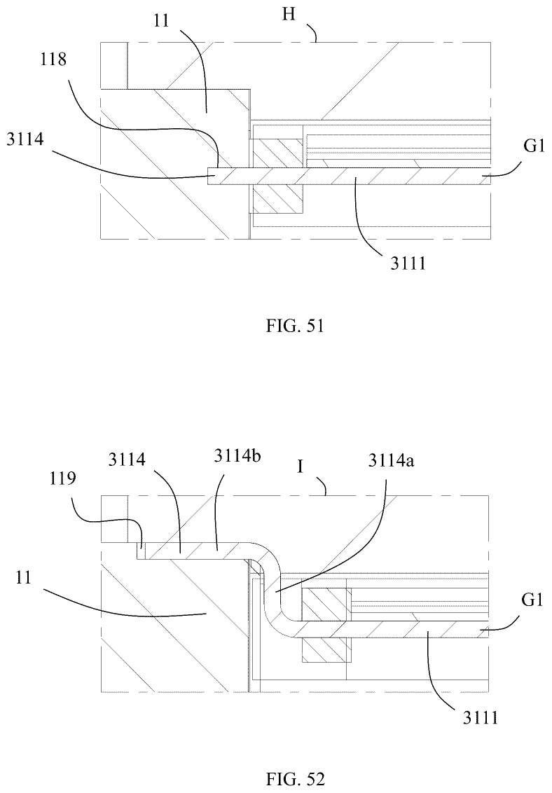

As shown in FIG. 51, in the first embodiment of the present disclosure, the first abutting portion 3114 and the first fixing portion 3111 of the first ground terminal G1 are aligned along the first direction A1-A1, and are located in a same plane. The first conductive body 11 defines a first receiving groove 118 for receiving the first abutting portion 3114. The first receiving groove 118 is recessed forwardly from the first rear surface 1115. When the first abutting portion 3114 is inserted into the first receiving groove 118, the first abutting portion 3114 comes into contact with the first conductive body 11. Therefore, the first conductive body 11 and the first ground terminal G1 are connected to form an integral grounding path to improve the grounding effect. The second abutting portion 3115 of the second ground terminal G2 has the same structure as the first abutting portion 3114 of the first ground terminal G1, and will not be described again in the present disclosure. In addition, as to the structure of the ground terminals in the second module M2, the third module M3 and the fourth module M4 and the matching structure with the corresponding conductive bodies, please refer to the structure of the first abutting portion 3114 and the second abutting portion 3115 in the first module M1, and the structure of the first conductive body 11, which will not be described again in the present disclosure.

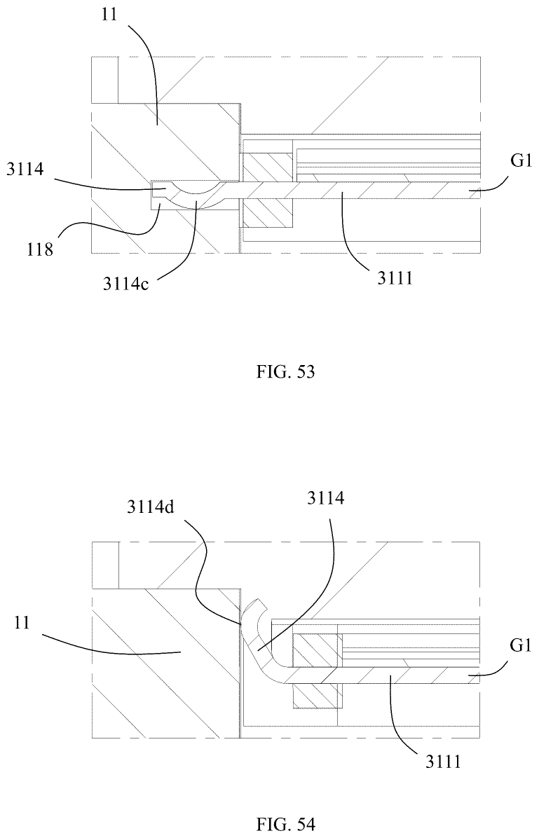

As shown in FIG. 53, in a second embodiment of the present disclosure, in order to improve the contact reliability between the first abutting portion 3114 and the first conductive body 11, the first abutting portion 3114 is further provided with at least one convex bump 3114c. The convex bump 3114c is in contact with the first conductive body 11. The convex bump 3114c is located on at least one side of the first abutting portion 3114. The convex bump 3114c and the first abutting portion 3114 are integrally formed. In one embodiment of the present disclosure, the convex bump 3114c is integrally stamped from the first abutting portion 3114. Of course, it is understandable to those skilled in the art that the convex bump 3114c can also be coupled to the first abutting portion 3114 in other ways, which will not be described in detail in the present disclosure. The second abutting portion 3115 of the second ground terminal G2 has the same structure as the first abutting portion 3114 of the first ground terminal G1, and will not be described in detail in the present disclosure. In addition, as to the structure of the ground terminals in the second module M2, the third module M3 and the fourth module M4, and the matching structure with the corresponding conductive bodies, please refer to the structure of the first abutting portion 3114 and the second abutting portion 3115 in the first module M1 and the structure of the first conductive body 11, which will not be described again in the present disclosure.

As shown in FIG. 52, in a third embodiment of the present disclosure, the first abutting portion 3114 and the first fixing portion 3111 of the first ground terminal G1 are not aligned along the first direction A1-A1 and located in different planes. Specifically, the first abutting portion 3114 is generally L-shaped, and includes a first bending portion 3114a connected to the first fixing portion 3111 of the first ground terminal G1, and a first extension portion 3114b extending from the first bending portion 3114a. The first bending portion 3114a extends along the third direction A3-A3, and the first extension portion 3114b extends along the first direction A1-A1. The first conductive body 11 defines a first slot 119 for receiving the first abutting portion 3114. The first slot 119 is recessed downwardly from the first upper surface 1111 of the first base portion 111. When the first abutting portion 3114 is installed into the first slot 119, the first extension portion 3114b of the first abutting portion 3114 comes into contact with the first conductive body 11. Therefore, the first conductive body 11 and the first ground terminal G1 are connected to form an integral grounding path to improve the grounding effect. The second abutting portion 3115 of the second ground terminal G2 has the same structure as the first abutting portion 3114 of the first ground terminal G1, and will not be described in detail in the present disclosure. In addition, as to the structure of the ground terminals in the second module M2, the third module M3 and the fourth module M4 and the matching structure with the corresponding conductive bodies, please refer to the structure of the first abutting portion 3114 and the second abutting portion 3115 in the first module M1, and the structure of the first conductive body 11, which will not be described again in the present disclosure.

Referring to FIG. 54, in a fourth embodiment of the present disclosure, the first abutting portion 3114 is in a shape of an elastic arm, which is bent from the first fixing portion 3111 of the first ground terminal G1. Specifically, the first abutting portion 3114 is provided with an abutting surface 3114d that abuts against the first conductive body 11, so that the first conductive body 11 and the first ground terminal G1 are connected to form an integral grounding path to improve the grounding effect. The second abutting portion 3115 of the second ground terminal G2 has the same structure as the first abutting portion 3114 of the first ground terminal G1, and will not be described in detail in the present disclosure. In addition, as to the structure of the ground terminals in the second module M2, the third module M3 and the fourth module M4 and the matching structure with the corresponding conductive bodies, please refer to the structure of the first abutting portion 3114 and the second abutting portion 3115 in the first module M1, and the structure of the first conductive body 11, which will not be described again in the present disclosure.

In the illustrated embodiment of the present disclosure, the first abutting portion 3114 is located at a free end of the first ground terminal G1. The first ground terminal G1 is not provided with a first contact arm 3113 protruding into the first receiving slot 11a. Similarly, the second abutting portion 3115 is located at a free end of the second ground terminal G2. The second ground terminal G2 is not provided with a first contact arm 3113 protruding into the first receiving slot 11a.

The first insulating fixing block 312 is at least partially fixed on the first fixing portion 3111 of the first signal terminal S1, the first fixing portion 3111 of the second signal terminal S2, the first fixing portion 3111 of the first ground terminal Gland the first fixing portion 3111 of the second ground terminal G2. The first contact arm 3113 of the first signal terminal S1 is connected to the first fixing portion 3111 of the first signal terminal S1. The first contact arm 3113 of the second signal terminal S2 is connected to the first fixing portion 3111 of the second signal terminal S2. The first abutting portion 3114 of the first ground terminal G1 is connected to the first fixing portion 3111 of the first ground terminal G1. The second abutting portion 3115 of the second ground terminal G2 is connected to the first fixing portion 3111 of the second ground terminal G2.

Besides, the first terminal module 31 further includes a first insulating combination block 316 fixed on the first signal terminal S1 and the second signal terminal S2. The first insulating combination block 316 is installed into the first terminal module installation slot 113 from the first installation opening 1116.

In the illustrated embodiment of the present disclosure, the first insulating combination block 316 and the first insulating fixing block 312 are spaced apart along the first direction A1-A1. Moreover, the first insulating combination block 316 is disposed closer to the first contact portion 3113a than the first insulating fixing block 312. Neither the first abutting portion 3114 nor the second abutting portion 3115 extends beyond the first insulating combination block 316.

The first ground plate 314 is installed on the first insulating fixing block 312. The first ground plate 314 includes a first mating portion 3141 in contact with at least part of the first fixing portion 3111 of the first ground terminal G1, a second mating portion 3142 in contact with at least part of the first fixing portion 3111 of the second ground terminal G2, and a first raised portion 3143 connecting the first mating portion 3141 and the second mating portion 3142. The first raised portion 3143 is not in contact with the first fixing portion 3111 of the first signal terminal S1 and the first fixing portion 3111 of the second signal terminal S2 in order to prevent short circuit.

In the illustrated embodiment of the present disclosure, the second insulating fixing block 313 is at least partially fixed on the second fixing portion 3112 of the first signal terminal S1, the second fixing portion 3112 of the second signal terminal S2, the second fixing portion 3112 of the first ground terminal G1 and the second fixing portion 3112 of the second ground terminal G2.

The first signal terminal S1 further includes a first mounting foot 3116 bent from the second fixing portion 3112 of the first signal terminal S1. The first mounting foot 3116 protrudes beyond the second insulating fixing block 313 and is configured to be mounted on the first signal conductive pad 2031 of the circuit board 200. The second signal terminal S2 further includes a second mounting foot 3117 bent from the second fixing portion 3112 of the second signal terminal S2. The second mounting foot 3117 protrudes beyond the second insulating fixing block 313 and is configured to be mounted on the second signal conductive pad 2032 of the circuit board 200. The first ground terminal G1 includes a first tail portion 3118 extending from the second fixing portion 3112 of the first ground terminal G1 and protruding beyond the second insulating fixing block 313. The second ground terminal G2 includes a second tail portion 3119 extending from the second fixing portion 3112 of the second ground terminal G2 and protruding beyond the second insulating fixing block 313. Neither the first tail portion 3118 nor the second tail portion 3119 is directly mounted to the circuit board 200.

In the illustrated embodiment of the present disclosure, the first mounting foot 3116 of the first signal terminal S1 is perpendicular to the second fixing portion 3112 of the first signal terminal S1. The second mounting foot 3117 of the second signal terminal S2 is perpendicular to the second fixing portion 3112 of the second signal terminal S2. The first tail portion 3118 of the first ground terminal G1 extends along the third direction A3-A3. The second tail portion 3119 of the second ground terminal G2 extends along the third direction A3-A3. In the illustrated embodiment of the present disclosure, the first mounting foot 3116 and the second mounting foot 3117 both extend backwardly and horizontally to be in contact with the first signal conductive pad 2031 and the second signal conductive pad 2032 of the circuit board 200, respectively. It is understandable to those skilled in the art that in the illustrated embodiment of the present disclosure, the first mounting foot 3116 and the second mounting foot 3117 can be soldered or welded to the first signal conductive pad 2031 and the second signal conductive pad 2032 of the circuit board 200, respectively, by surface mounted technology (SMT).

The second ground plate 315 is installed on the second insulating fixing block 313. The second ground plate 315 includes a third mating portion 3151 in contact with at least part of the second fixing portion 3112 of the first ground terminal G1, a fourth mating portion 3152 in contact with at least part of the second fixing portion 3112 of the second ground terminal G2, and a second raised portion 3153 connecting the third mating portion 3151 and the fourth mating portion 3152. The second raised portion 3153 is not in contact with the second fixing portion 3112 of the first signal terminal S1 and the second fixing portion 3112 of the second signal terminal S2 in order to prevent short circuit.

In the illustrated embodiment of the present disclosure, by providing the first ground plate 314 and the second ground plate 315, all the first ground terminals G1 and all the second ground terminals G2 are connected in series, which is beneficial to improving the ground shielding effect and improving the quality of signal transmission.

In the illustrated embodiment of the present disclosure, two first ground sheets 41 are provided and made of metal material. Each first ground sheet 41 is generally U-shaped and includes a first mounting plate 411, a second mounting plate 412 disposed opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124. The first extension plate 414 is received in a corresponding first recess 1118 of the first conductive body 11. The first extension plate 414 defines a plurality of first mounting holes 4141 to receive the first mounting protrusions 1119.

The first connecting plate 413 abuts against and at least partially covers the first front surface 210 of the first insulating block 21. The first connecting plate 413 is located at a front end of the first mating slot 101 along the first direction A1-A1. When the mating module is inserted, the tongue plate may be in contact with the first connecting plate 413 first, thereby facilitating the discharge of static electricity. The second mounting plate 412 is provided with a plurality of first grounding elastic arms 415 spaced apart along the second direction A2-A2. The first grounding elastic arms 415 are disposed on two sides of the first contact arms 3113 of each group of first conductive terminals 311 so as to improve the shielding effect and improve the quality of signal transmission.

In an embodiment of the present disclosure, the first positioning post 1124 is fixed to the first mounting positioning hole 4111, so that the first mounting plate 411 is fixed on the second upper surface 1121 of the first protruding portion 112. In an embodiment of the present disclosure, a dimension of the first mounting hole 4141 along the first direction A1-A1 is slightly larger than a dimension of the first mounting protrusion 1119 along the first direction A1-A1. Therefore, when the first grounding elastic arm 415 is deformed by the first ground contact pad of the mating module, the first extension plate 414 can move appropriately in the first recess 1118 along the first direction A1-A1.

In the illustrated embodiment of the present disclosure, the second module M2 includes a second conductive body 12, a second insulating block 22 fixed to the second conductive body 12, a second insulating block 22 mounted to the second conductive body 12, a second terminal module 32 mounted to the second conductive body 12, and a second ground sheet 42 fixed to the second conductive body 12.

In an embodiment of the present disclosure, the second conductive body 12 is a metal housing made of metal material so as to further improve the shielding effect and improve the quality of signal transmission. In another embodiment of the present disclosure, the second conductive body 12 may also be a composite housing formed by electroplating a metal material on an insulating material. The composite housing can also improve the shielding effect and improve the quality of signal transmission.

In one embodiment of the present disclosure, the second conductive body 12 includes a second base portion 121 and a second protruding portion 122 extending forwardly from the second base portion 121. The second base portion 121 includes a third upper surface 1211, a third lower surface 1212 and a second rear surface 1215. A top of the second base portion 121 further defines at least one second recess 1218 disposed adjacent to the second protruding portion 122. In the illustrated embodiment of the present disclosure, two second recesses 1218 are provided. The second base portion 121 is further provided with a plurality of second mounting protrusions 1219 protruding into each second recess 1218.

The second protruding portion 122 includes a fourth upper surface 1221, a fourth lower surface 1222, and a plurality of second filling grooves 1223 extending downwardly through the fourth lower surface 1222 along the third direction A3-A3. The second filling groove 1223 extends forwardly through a second front end surface 1220 of the second protruding portion 122 along the first direction A1-A1. The second protruding portion 122 further includes a plurality of second positioning posts 1224 protruding downwardly beyond the fourth lower surface 1222 along the third direction A3-A3.

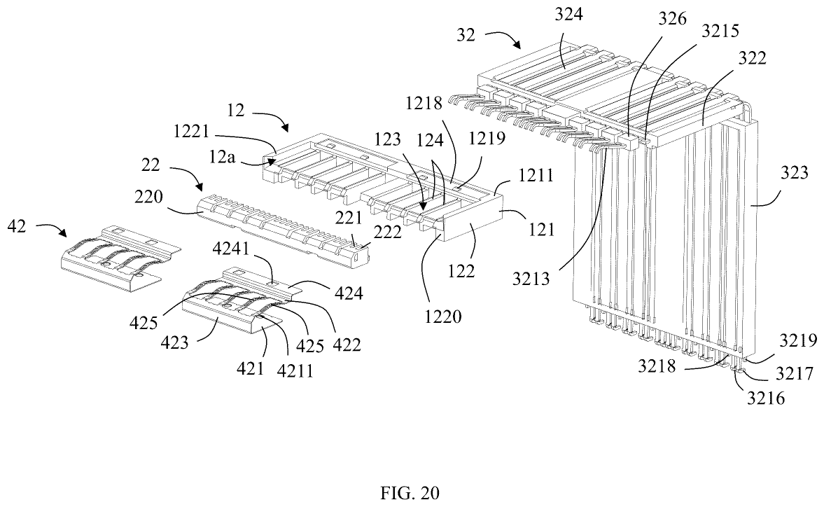

Referring to FIG. 20, in the illustrated embodiment of the present disclosure, the second conductive body 12 further includes a plurality of second terminal module installation slots 123 extending along the first direction A1-A1. Each second terminal module installation slot 123 extends from the second base portion 121 to the second protruding portion 122. A rear end of the second terminal module installation slot 123 extends through the second rear surface 1215 to form a second installation opening 1216. A middle portion of the second terminal module installation groove 123 is circumferentially surrounded by walls of the second conductive body 12. A front end of the second terminal module installation slot 123 extends upwardly through the fourth upper surface 1221. It is understandable to those skilled in the art that by arranging the middle portion of the second terminal module installation slot 123 to be surrounded by the walls of the second conductive body 12 in a circumferential direction, on the one hand, the conductive terminals located in the second terminal module installation slots 123 can be better shielded; and on the other hand, adjacent second terminal module installation slots 123 can be well separated, thereby reducing signal crosstalk. In addition, the second conductive body 12 further includes a second receiving slot 12a extending along the first direction A1-A1 and extending forwardly through the second protruding portion 122.

The plurality of second terminal module installation slots 123 are spaced apart along the second direction A2-A2. The second conductive body 12 includes a plurality of second partition walls 124 spaced apart along the second direction A2-A2. Two adjacent second terminal module installation slots 123 are separated by a corresponding second partition wall 124 along the second direction A2-A2. With this arrangement, each second terminal module installation slot 123 is relatively independent, thereby reducing signal crosstalk and improving the quality of data transmission.

The second insulating block 22 is fixed in the second filling grooves 1223. Preferably, in order to increase the bonding force between the second insulating block 22 and the second conductive body 12, the second insulating block 22 is formed in the second filling grooves 1223. The second insulating block 22 defines a plurality of third slits 221 and a plurality of fourth slits 222, in which adjacent third slit 221 and fourth slit 222 form a group and communicate with a corresponding second terminal module installation slot 123. The second insulating block 22 further includes a second front surface 220 which is coplanar with the second front end surface 1220 of the second protruding portion 122.

The second terminal module 32 includes a plurality of second conductive terminals 321, a third insulating fixing block 322 fixed on at least part of the second conductive terminals 321, a fourth insulating fixing block 323 fixed on at least part of the second conductive terminals 321, a third ground plate 324 installed on the third insulating fixing block 322, and a fourth ground plate 325 installed on the fourth insulating fixing block 323.

The plurality of second conductive terminals 321 include a third signal terminal S3, a fourth signal terminal S4, a third ground terminal G3 located on one side of the third signal terminal S3 and the fourth signal terminal S4, and a fourth ground terminal G4 located on another side of the third signal terminal S3 and the fourth signal terminal S4. Preferably, the third signal terminal S3 and the fourth signal terminal S4 in each group of second conductive terminals 321 form a differential pair to improve signal transmission speed. The third ground terminal G3, the third signal terminal S3, the fourth signal terminal S4 and the fourth ground terminal G4 are disposed in sequence along the second direction A2-A2.

In the illustrated embodiment of the disclosure, each second conductive terminal 321 includes a third fixing portion 3211 and a fourth fixing portion 3212 bent from the third fixing portion 3211. The third fixing portion 3211 extends along the first direction A1-A1. The fourth fixing portion 3212 extends along the third direction A3-A3.

Besides, the third signal terminal S3 and the fourth signal terminal S4 each include a second contact arm 3213 protruding forwardly beyond the third insulating fixing block 322 along the first direction A1-A1. The second contact arm 3213 includes a second contact portion 3213a protruding into the second receiving slot 12a. Neither the third signal terminal S3 nor the fourth signal terminal S4 is in contact with the second conductive body 12 in order to prevent short circuit. The third ground terminal G3 includes a third abutting portion 3214 protruding beyond the third insulating fixing block 322 along the first direction A1-A1. The fourth ground terminal G4 includes a fourth abutting portion 3215 protruding beyond the third insulating fixing block 322. At least one of the third abutting portion 3214 and the fourth abutting portion 3215 is in contact with the second conductive body 12 to achieve grounding. In the illustrated embodiment of the present disclosure, the third abutting portion 3214 and the fourth abutting portion 3215 are both in contact with the second conductive body 12 to achieve grounding. The third abutting portion 3214 is in elastic contact or inelastic contact with the second conductive body 12; and/or the fourth abutting portion 3215 is in elastic contact or inelastic contact with the second conductive body 12.

The third abutting portion 3214 is located at a free end of the third ground terminal G3. The third ground terminal G3 is not provided with a second contact arm 3213 protruding into the second receiving slot 12a. Similarly, the fourth abutting portion 3215 is located at a free end of the fourth ground terminal G4. The fourth ground terminal G4 is not provided with a second contact arm 3213 protruding into the second receiving slot 12a.

The third insulating fixing block 322 is at least partially fixed on the third fixing portion 3211 of the third signal terminal S3, the third fixing portion 3211 of the fourth signal terminal S4, the third fixing portion 3211 of the third ground terminal G3 and the third fixing portion 3211 of the fourth ground terminal G4. The second contact arm 3213 of the third signal terminal S3 is connected to the third fixing portion 3211 of the third signal terminal S3. The second contact arm 3213 of the fourth signal terminal S4 is connected to the third fixing portion 3211 of the fourth signal terminal S4. The third abutting portion 3214 of the third ground terminal G3 is connected to the third fixing portion 3211 of the third ground terminal G3. The fourth abutting portion 3215 of the fourth ground terminal G4 is connected to the third fixing portion 3211 of the fourth ground terminal G4.

Besides, the second terminal module 32 further includes a second insulating combination block 326 fixed on the third signal terminal S3 and the fourth signal terminal S4. The second insulating combination block 326 is installed into the second terminal module installation slot 123 from the second installation opening 1216.

In the illustrated embodiment of the present disclosure, the second insulating combination block 326 and the third insulating fixing block 322 are spaced apart along the first direction A1-A1. Moreover, the second insulating combination block 326 is disposed closer to the second contact portion 3213a than the third insulating fixing block 322. Neither the third abutting portion 3214 nor the fourth abutting portion 3215 extends beyond the second insulating combination block 326.

The third ground plate 324 is installed on the third insulating fixing block 322. The third ground plate 324 includes a fifth mating portion 3241 in contact with at least part of the third fixing portion 3211 of the third ground terminal G3, a sixth mating portion 3242 in contact with at least part of the third fixing portion 3211 of the fourth ground terminal G4, and a third raised portion 3243 connecting the fifth mating portion 3241 and the sixth mating portion 3242. The third raised portion 3243 is not in contact with the third fixing portion 3211 of the third signal terminal S3 and the third fixing portion 3211 of the fourth signal terminal S4 in order to prevent short circuit.

In the illustrated embodiment of the present disclosure, the fourth insulating fixing block 323 is at least partially fixed on the fourth fixing portion 3212 of the third signal terminal S3, the fourth fixing portion 3212 of the fourth signal terminal S4, the fourth fixing portion 3212 of the third ground terminal G3 and the fourth fixing portion 3212 of the fourth ground terminal G4.

The third signal terminal S3 further includes a third mounting foot 3216 bent from the fourth fixing portion 3212 of the third signal terminal S3. The third mounting foot 3216 protrudes beyond the fourth insulating fixing block 323 and is configured to be mounted on the third signal conductive pad 2041 of the circuit board 200. The fourth signal terminal S4 further includes a fourth mounting foot 3217 bent from the fourth fixing portion 3212 of the fourth signal terminal S4. The fourth mounting foot 3217 protrudes beyond the fourth insulating fixing block 323 and is configured to be mounted on the fourth signal conductive pad 2042 of the circuit board 200. The third ground terminal G3 includes a third tail portion 3218 extending from the fourth fixing portion 3212 of the third ground terminal G3 and protruding beyond the fourth insulating fixing block 323. The fourth ground terminal G4 includes a fourth tail portion 3219 extending from the fourth fixing portion 3212 of the fourth ground terminal G4 and protruding beyond the fourth insulating fixing block 323. Neither the third tail portion 3218 nor the fourth tail portion 3219 is directly mounted to the circuit board 200.

In the illustrated embodiment of the present disclosure, the third mounting foot 3216 of the third signal terminal S3 is perpendicular to the fourth fixing portion 3212 of the third signal terminal S3. The fourth mounting foot 3217 of the fourth signal terminal S4 is perpendicular to the fourth fixing portion 3212 of the fourth signal terminal S4. The third tail portion 3218 of the third ground terminal G3 extends along the third direction A3-A3. The fourth tail portion 3219 of the fourth ground terminal G4 extends along the third direction A3-A3. In the illustrated embodiment of the present disclosure, the third mounting foot 3216 and the fourth mounting foot 3217 both extend backwardly and horizontally to be in contact with the third signal conductive pad 2041 and the fourth signal conductive pad 2041 of the circuit board 200, respectively. It is understandable to those skilled in the art that in the illustrated embodiment of the present disclosure, the third mounting foot 3216 and the fourth mounting foot 3217 can be soldered or welded to the third signal conductive pad 2041 and the fourth signal conductive pad 2041 of the circuit board 200, respectively, by surface mounted technology (SMT).

The fourth ground plate 325 is installed on the fourth insulating fixing block 323. The fourth ground plate 325 includes a seventh mating portion 3251 in contact with at least part of the fourth fixing portion 3212 of the third ground terminal G3, an eighth mating portion 3252 in contact with at least part of the fourth fixing portion 3212 of the fourth ground terminal G4, and a fourth raised portion 3253 connecting the seventh mating portion 3251 and the eighth mating portion 3252. The fourth raised portion 3253 is not in contact with the fourth fixing portion 3212 of the third signal terminal S3 and the fourth fixing portion 3212 of the fourth signal terminal S4 in order to prevent short circuit.

In the illustrated embodiment of the present disclosure, by providing the third ground plate 324 and the fourth ground plate 325, all the third ground terminals G3 and all the fourth ground terminals G4 are connected in series, which is beneficial to improving the ground shielding effect and improving the quality of signal transmission.

In the illustrated embodiment of the present disclosure, two second ground sheets 42 are provided and made of metal material. Each second ground sheet 42 is generally U-shaped and includes a third mounting plate 421, a fourth mounting plate 422 disposed opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224. The second extension plate 424 is received in a corresponding second recess 1218 of the second conductive body 12. The second extension plate 424 defines a plurality of second mounting holes 4241 to receive the second mounting protrusions 1219.

The second connecting plate 423 abuts against and at least partially covers a second front surface 220 of the second insulating block 22. The second connecting plate 423 is located at a front end of the first mating slot 101 along the first direction A1-A1. When the mating module is inserted, the tongue plate may be in contact with the second connecting plate 423 first, thereby facilitating the discharge of static electricity. The fourth mounting plate 422 is provided with a plurality of second grounding elastic arms 425 spaced apart along the second direction A2-A2. The second grounding elastic arms 425 are disposed on two sides of the second contact arms 3213 of each group of second conductive terminals 321 so as to improve the shielding effect and improve the quality of signal transmission.

In one embodiment of the present disclosure, the second positioning post 1224 is fixed to the second installation positioning hole 4211, so that the third mounting plate 421 is fixed on the fourth upper surface 1221 of the second protruding portion 122. In one embodiment of the present disclosure, a dimension of the second mounting hole 4241 along the first direction A1-A1 is slightly larger than a dimension of the second mounting protrusion 1219 along the first direction A1-A1. Therefore, when the second grounding elastic arm 425 is deformed by the first ground contact pad of the mating module, the second extension plate 424 can move appropriately in the second recess 1218 along the first direction A1-A1.

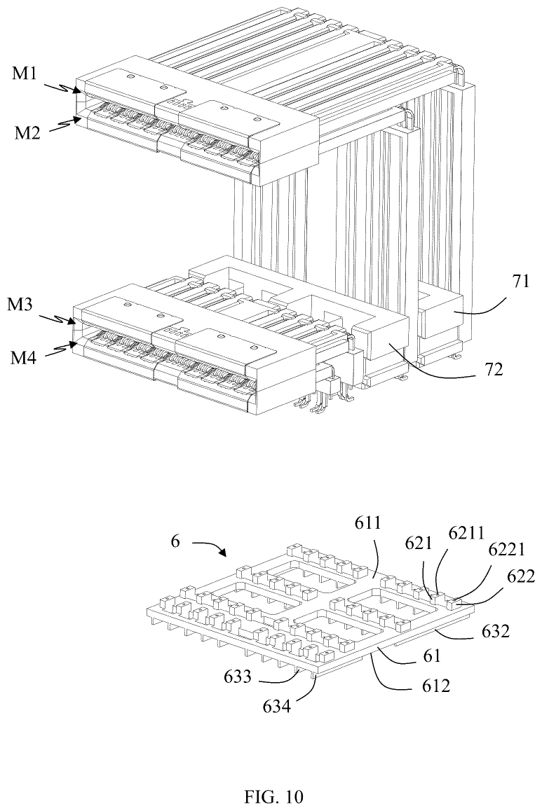

As shown in FIG. 10, in an embodiment of the present disclosure, the first conductive body 11 and the second conductive body 12 are fixed together. For example, after the first conductive body 11 and the second conductive body 12 are assembled, they are fixed together by soldering or welding or other methods. The first receiving slot 11a and the second receiving slot 12a are in communication with each other to form the first mating slot 101.

In the illustrated embodiment of the present disclosure, the third module M3 includes a third conductive body 13, a third insulating block 23 fixed to the third conductive body 13, a third terminal module 33 mounted to the third conductive body 13, and a third ground sheet 43 is fixed to the third conductive body 13.

In an embodiment of the present disclosure, the third conductive body 13 is a metal housing made of metal material so as to further improve the shielding effect and improve the quality of signal transmission. In another embodiment of the present disclosure, the third conductive body 13 may also be a composite housing formed by electroplating a metal material on an insulating material. The composite housing can also improve the shielding effect and improve the quality of signal transmission.

In one embodiment of the present disclosure, the third conductive body 13 includes a third base portion 131 and a third protruding portion 132 extending forwardly from the third base portion 131. The third base portion 131 is provided with a fifth upper surface 1311, a fifth lower surface 1312 and a third rear surface 1315. A bottom of the third base portion 131 further defines at least one third recess 1318 disposed close to the third protruding portion 132. In the illustrated embodiment of the present disclosure, two third recesses 1318 are provided. The third base portion 131 is further provided with a plurality of third mounting protrusions 1319 protruding into each third recess 1318.

The third protruding portion 132 includes a sixth upper surface 1321, a sixth lower surface 1322, and a plurality of third filling grooves 1323 extending upwardly through the sixth upper surface 1321 along the third direction A3-A3. The third filling groove 1323 extends forwardly through a third front end surface 1320 of the third protruding portion 132 along the first direction A1-A1. The third protruding portion 132 further includes a plurality of third positioning posts 1324 protruding upwardly beyond the sixth upper surface 1321 along the third direction A3-A3.

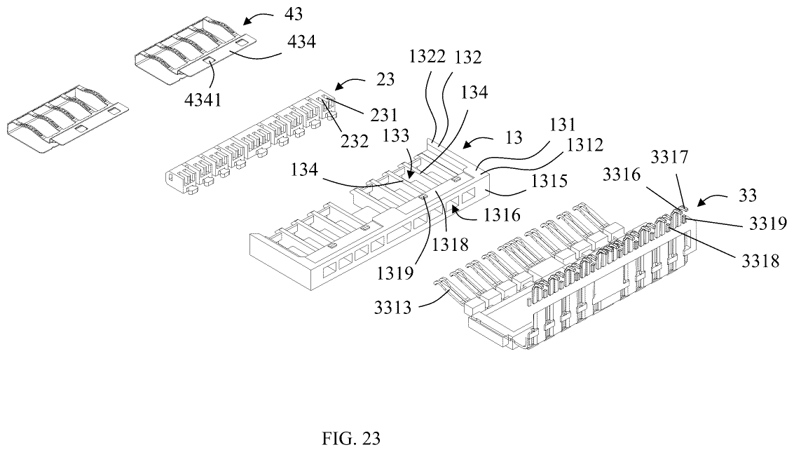

Referring to FIG. 23, in the illustrated embodiment of the present disclosure, the third conductive body 13 further includes a plurality of third terminal module installation slots 133 extending along the first direction A1-A1. Each third terminal module installation slot 133 extends from the third base portion 131 to the third protruding portion 132. A rear end of the third terminal module installation slot 133 extends through the third rear surface 1315 to form a third installation opening 1316. A middle portion of the third terminal module installation slot 133 is circumferentially surrounded by walls of the third conductive body 13. A front end of the third terminal module installation slot 133 extends downwardly through the sixth lower surface 1322. It is understandable to those skilled in the art that by arranging the middle portion of the third terminal module installation slot 133 to be surrounded by the walls of the third conductive body 13 in a circumferential direction, on the one hand, the conductive terminals located in the third terminal module installation slots 133 can be better shielded; and on the other hand, adjacent third terminal module installation slots 133 can be well separated, thereby reducing signal crosstalk. In addition, the third conductive body 13 further defines a second receiving slot 13a extending along the first direction A1-A1 and extending forwardly through the third protruding portion 132.

The plurality of third terminal module installation slots 133 are spaced apart along the second direction A2-A2. The third conductive body 13 includes a plurality of third partition walls 134 spaced apart along the second direction A2-A2. Two adjacent third terminal module installation slots 133 are separated by a corresponding third partition wall 134 along the second direction A2-A2. With this arrangement, each third terminal module installation slot 133 is relatively independent, thereby reducing signal crosstalk and improving the quality of data transmission.

The third insulating block 23 is fixed in the third filling grooves 1323. Preferably, in order to increase the bonding force between the third insulating block 23 and the third conductive body 13, the third insulating block 23 is formed in the third filling grooves 1323. The third insulating block 23 defines a plurality of fifth slits 231 and a plurality of sixth slits 232 in which the adjacent fifth slit 231 and sixth slit 232 form a group and are in communication with a corresponding third terminal module installation slot 133. The third insulating block 23 further includes a third front surface 230 which is coplanar with the third front end surface 1320 of the third protruding portion 132.

The third terminal module 33 includes a plurality of third conductive terminals 331, a fifth insulating fixing block 332 fixed on at least part of the third conductive terminals 331, a sixth insulating fixing block 333 fixed on at least part of the third conductive terminals 331, a fifth ground plate 334 installed on the fifth insulating fixing block 332, and a sixth ground plate 335 installed on the sixth insulating fixing block 333.

The plurality of third conductive terminals 331 include a fifth signal terminal S5, a sixth signal terminal S6, a fifth ground terminal G5 located on one side of the fifth signal terminal S5 and the sixth signal terminal S6, and a sixth ground terminal G6 located on another side of the fifth signal terminal S5 and the sixth signal terminal S6. Preferably, the fifth signal terminal S5 and the sixth signal terminal S6 in each group of third conductive terminals 331 form a differential pair to improve signal transmission speed. The fifth ground terminal G5, the fifth signal terminal S5, the sixth signal terminal S6 and the sixth ground terminal G6 are disposed in sequence along the second direction A2-A2.

In the illustrated embodiment of the present disclosure, each third conductive terminal 331 includes a fifth fixing portion 3311 and a sixth fixing portion 3312 bent from the fifth fixing portion 3311. The fifth fixing portion 3311 extends along the first direction A1-A1. The sixth fixing portion 3312 extends along the third direction A3-A3.

Besides, the fifth signal terminal S5 and the sixth signal terminal S6 each include a third contact arm 3313 protruding forwardly beyond the fifth insulating fixing block 332 along the first direction A1-A1. The third contact arm 3313 includes a third contact portion 3313a protruding into the third receiving slot 13a. Neither the fifth signal terminal S5 nor the sixth signal terminal S6 is in contact with the third conductive body 13 in order to prevent short circuit. The fifth ground terminal G5 includes a fifth abutting portion 3314 protruding beyond the fifth insulating fixing block 332 along the first direction A1-A1. The sixth ground terminal G6 includes a sixth abutting portion 3315 protruding beyond the fifth insulating fixing block 332. At least one of the fifth abutting portion 3314 and the sixth abutting portion 3315 is in contact with the third conductive body 13 to achieve grounding. In the illustrated embodiment of the present disclosure, both the fifth abutting portion 3314 and the sixth abutting portion 3315 are in contact with the third conductive body 13 to achieve grounding. The fifth abutting portion 3314 is in elastic contact or inelastic contact with the third conductive body 13; and/or the sixth abutting portion 3315 is in elastic contact or inelastic contact with the third conductive body 13.

The fifth abutting portion 3314 is located at a free end of the fifth ground terminal G5. The fifth ground terminal G5 is not provided with a third contact arm 3313 protruding into the third receiving slot 13a. Similarly, the sixth abutting portion 3315 is located at a free end of the sixth ground terminal G6. The sixth ground terminal G6 is not provided with a third contact arm 3313 protruding into the third receiving slot 13a.

The fifth insulating fixing block 332 is at least partially fixed on the fifth fixing portion 3311 of the fifth signal terminal S5, the fifth fixing portion 3311 of the sixth signal terminal S6, the fifth fixing portion 3311 of the fifth ground terminal G5 and the fifth fixing portion 3311 of the sixth ground terminal G6. The third contact arm 3313 of the fifth signal terminal S5 is connected to the fifth fixing portion 3311 of the fifth signal terminal S5. The third contact arm 3313 of the sixth signal terminal S6 is connected to the fifth fixing portion 3311 of the sixth signal terminal S6. The fifth abutting portion 3314 of the fifth ground terminal G5 is connected to the fifth fixing portion 3311 of the fifth ground terminal G5. The sixth abutting portion 3315 of the sixth ground terminal G6 is connected to the fifth fixing portion 3311 of the sixth ground terminal G6.

In addition, the third terminal module 33 further includes a third insulating combination block 336 fixed on the fifth signal terminal S5 and the sixth signal terminal S6. The third insulating combination block 336 is installed into the third terminal module installation slot 133 from the third installation opening 1316.

In the illustrated embodiment of the present disclosure, the third insulating combination block 336 and the fifth insulating fixing block 332 are spaced apart along the first direction A1-A1. Moreover, the third insulating combination block 336 is disposed closer to the third contact portion 3313a than the fifth insulating fixing block 332. Neither the fifth abutting portion 3314 nor the sixth abutting portion 3315 extends beyond the third insulating combination block 336.

The fifth ground plate 334 is installed on the fifth insulating fixing block 332. The fifth ground plate 334 includes a ninth mating portion 3341 in contact with at least part of the fifth fixing portion 3311 of the fifth ground terminal G5, a tenth mating portion 3342 in contact with at least part of the fifth fixing portion 3311 of the sixth ground terminal G6, and a fifth raised portion 3343 connecting the ninth mating portion 3341 and the tenth mating portion 3342. The fifth raised portion 3343 is not in contact with the fifth fixing portion 3311 of the fifth signal terminal S5 and the fifth fixing portion 3311 of the sixth signal terminal S6 in order to prevent short circuit.

In the illustrated embodiment of the present disclosure, the sixth insulating fixing block 333 is at least partially fixed on the sixth fixing portion 3312 of the fifth signal terminal S5, the sixth fixing portion 3312 of the sixth signal terminal S6, the sixth fixing portion 3312 of the fifth ground terminal G5, and the sixth fixing portion 3312 of the sixth ground terminal G6.

The fifth signal terminal S5 further includes a fifth mounting foot 3316 bent from the sixth fixing portion 3312 of the fifth signal terminal S5. The fifth mounting foot 3316 protrudes beyond the sixth insulating fixing block 333 and is configured to be mounted to the fifth signal conductive pad 2051 of the circuit board 200. The sixth signal terminal S6 further includes a sixth mounting foot 3317 bent from the sixth fixing portion 3312 of the sixth signal terminal S6. The sixth mounting foot 3317 protrudes beyond the sixth insulating fixing block 333 and is configured to be mounted to the sixth signal conductive pad 2052 of the circuit board 200. The fifth ground terminal G5 includes a fifth tail portion 3318 extending from the sixth fixing portion 3312 of the fifth ground terminal G5 and protruding beyond the sixth insulating fixing block 333. The sixth ground terminal G6 includes a sixth tail portion 3319 extending from the sixth fixing portion 3312 of the sixth ground terminal G6 and protruding beyond the sixth insulating fixing block 333. Neither the fifth tail portion 3318 nor the sixth tail portion 3319 is directly mounted to the circuit board 200.

In the illustrated embodiment of the present disclosure, the fifth mounting foot 3316 of the fifth signal terminal S5 is perpendicular to the sixth fixing portion 3312 of the fifth signal terminal S5. The sixth mounting foot 3317 of the sixth signal terminal S6 is perpendicular to the sixth fixing portion 3312 of the sixth signal terminal S6. The fifth tail portion 3318 of the fifth ground terminal G5 extends along the third direction A3-A3. The sixth tail portion 3319 of the sixth ground terminal G6 extends along the third direction A3-A3. In the illustrated embodiment of the present disclosure, the fifth mounting foot 3316 and the sixth mounting foot 3317 both extend backwardly and horizontally to be in contact with the fifth signal conductive pad 2051 and the sixth signal conductive pad 2051 of the circuit board 200, respectively. It is understandable to those skilled in the art that in the illustrated embodiment of the present disclosure, the fifth mounting foot 3316 and the sixth mounting foot 3317 can be soldered or welded to the fifth signal conductive pad 2051 and the sixth signal conductive pad 2051 of the circuit board 200, respectively, by surface mounted technology (SMT).

The sixth ground plate 335 is installed on the sixth insulating fixing block 333. The sixth ground plate 335 includes an eleventh mating portion 3351 in contact with at least part of the sixth fixing portion 3312 of the fifth ground terminal G5, a twelfth mating portion 3352 in contact with at least part of the sixth fixing portion 3312 of the sixth ground terminal G6, and a sixth raised portion 3353 connecting the eleventh mating portion 3351 and the twelfth mating portion 3352. The sixth raised portion 3353 is not in contact with the sixth fixing portion 3312 of the fifth signal terminal S5 and the sixth fixing portion 3312 of the sixth signal terminal S6 in order to prevent short circuit.

In the illustrated embodiment of the present disclosure, by providing the fifth ground plate 334 and the sixth ground plate 335, all fifth ground terminals G5 and all sixth ground terminals G6 are connected in series, which is beneficial to improving the ground shielding effect and improving the quality of signal transmission.

In the illustrated embodiment of the present disclosure, two third ground sheets 43 are provided and made of metal material. Each third ground sheet 43 is generally U-shaped and includes a fifth mounting plate 431, a sixth mounting plate 432 disposed opposite to the fifth mounting plate 431, a third connecting plate 433 connecting one side of the fifth mounting plate 431 and one side of the sixth mounting plate 432, and a third extension plate 434 extending downwardly and backwardly from another side of the sixth mounting plate 432. The fifth mounting plate 431 defines a plurality of third mounting positioning holes 4311 that match the third positioning posts 1324. The third extension plate 434 is received in a corresponding third recess 1318 of the third conductive body 13. The third extension plate 434 defines a plurality of third mounting holes 4341 to receive the third mounting protrusions 1319.

The third connecting plate 433 abuts against and at least partially covers the third front surface 230 of the third insulating block 23. The third connecting plate 433 is located at a front end of the second mating slot 102 along the first direction A1-A1. When the mating module is inserted, the tongue plate may be in contact with the third connecting plate 433 first, thereby facilitating the discharge of static electricity. The sixth mounting plate 432 is provided with a plurality of third grounding elastic arms 435 spaced apart along the second direction A2-A2. The third grounding elastic arms 435 are disposed on two sides of the third contact arms 3313 of each group of third conductive terminals 331 so as to improve the shielding effect and improve the quality of signal transmission.

In one embodiment of the present disclosure, the third positioning post 1324 is fixed to the third mounting positioning hole 4311, so that the fifth mounting plate 431 is fixed on the sixth upper surface 1321 of the third protruding portion 132. In one embodiment of the present disclosure, a dimension of the third mounting hole 4341 along the first direction A1-A1 is slightly larger than a dimension of the third mounting protrusion 1319 along the first direction A1-A1. Therefore, when the third grounding elastic arm 435 is deformed by the first ground contact pad of the mating module, the third extension plate 434 can move appropriately in the third recess 1318 along the first direction A1-A1.

In the illustrated embodiment of the present disclosure, the fourth module M4 includes a fourth conductive body 14, a fourth insulating block 24 fixed to the fourth conductive body 14, a fourth terminal module 34 mounted to the fourth conductive body 14, and a fourth ground sheet 44 fixed to the fourth conductive body 14.

In an embodiment of the present disclosure, the fourth conductive body 14 is a metal housing made of metal material so as to further improve the shielding effect and improve the quality of signal transmission. In another embodiment of the present disclosure, the fourth conductive body 14 may also be a composite housing formed by electroplating a metal material on an insulating material. The composite housing can also improve the shielding effect and improve the quality of signal transmission.

In an embodiment of the present disclosure, the fourth conductive body 14 includes a fourth base portion 141 and a fourth protruding portion 142 extending forwardly from the fourth base portion 141. The fourth base portion 141 includes a seventh upper surface 1411, a seventh lower surface 1412 and a fourth rear surface 1415. A bottom of the fourth base portion 141 further defines at least one fourth recess 1418 disposed close to the fourth protruding portion 142. In the illustrated embodiment of the present disclosure, two fourth recesses 1418 are provided. The fourth base portion 141 further includes a plurality of fourth mounting protrusions 1419 protruding into each fourth recess 1418.

The fourth protruding portion 142 includes an eighth upper surface 1421, an eighth lower surface 1422, and a plurality of fourth filling grooves 1423 extending downwardly through the eighth lower surface 1422 along the third direction A3-A3. The fourth filling groove 1423 extends forwardly through a fourth front end surface 1420 of the fourth protruding portion 142 along the first direction A1-A1. The fourth protruding portion 142 further includes a plurality of fourth positioning posts 1424 protruding downwardly beyond the eighth lower surface 1422 along the third direction A3-A3.

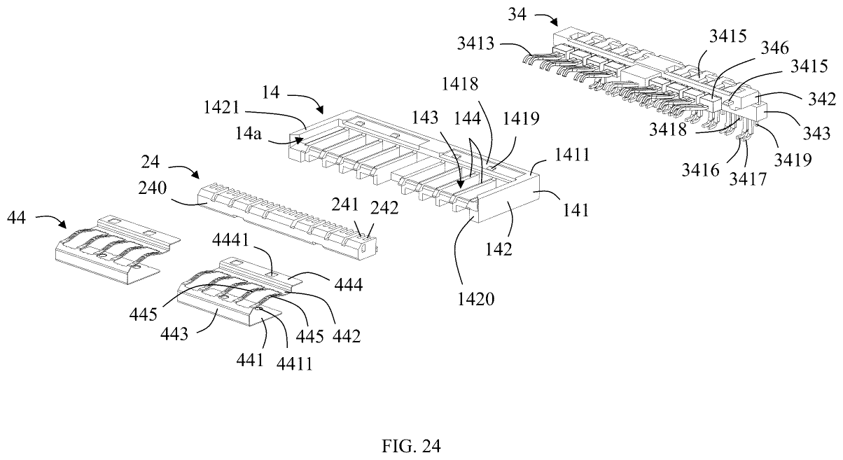

Referring to FIG. 24, in the illustrated embodiment of the present disclosure, the fourth conductive body 14 further includes a plurality of fourth terminal module installation slots 143 extending along the first direction A1-A1. Each fourth terminal module installation slot 143 extends from the fourth base portion 141 to the fourth protruding portion 142. A rear end of the fourth terminal module installation slot 143 extends through the fourth rear surface 1415 to form a fourth installation opening 1416. A middle portion of the fourth terminal module installation slot 143 is circumferentially surrounded by walls of the fourth conductive body 14. A front end of the fourth terminal module installation slot 143 extends upwardly through the eighth upper surface 1421. It is understandable to those skilled in the art that by arranging the middle portion of the fourth terminal module installation slot 143 to be surrounded by the walls of the fourth conductive body 14 in a circumferential direction, on the one hand, the conductive terminals located in the fourth terminal module installation slots 143 can be better shielded; and on the other hand, adjacent fourth terminal module installation slots 143 can be well separated, thereby reducing signal crosstalk. In addition, the fourth conductive body 14 further defines a fourth receiving slot 14a extending along the first direction A1-A1 and extending forwardly through the fourth protruding portion 142.

The plurality of fourth terminal module installation slots 143 are spaced apart along the second direction A2-A2. The fourth conductive body 14 includes a plurality of fourth partition walls 144 spaced apart along the second direction A2-A2. Two adjacent fourth terminal module installation slots 143 are separated by a corresponding fourth partition wall 144 along the second direction A2-A2. With this arrangement, each fourth terminal module installation slot 143 is relatively independent, thereby reducing signal crosstalk and improving the quality of data transmission.

The fourth insulating block 24 is fixed in the fourth filling grooves 1423. Preferably, in order to increase the bonding force between the fourth insulating block 24 and the fourth conductive body 14, the fourth insulating block 24 is formed in the fourth filling grooves 1423. The fourth insulating block 24 defines a plurality of seventh slits 241 and a plurality of eighth slits 242 in which adjacent seventh slit 241 and eighth slit 242 are formed into a group and are in communication with a corresponding fourth terminal module installation slot 143. The fourth insulating block 24 further includes a fourth front surface 240 which is coplanar with the fourth front end surface 1420 of the fourth protruding portion 142.

The fourth terminal module 34 includes a plurality of fourth conductive terminals 341, a seventh insulating fixing block 342 fixed on at least part of the fourth conductive terminals 341, an eighth insulating fixing block 343 fixed on at least part of the fourth conductive terminals 341, and a seventh ground plate 344 installed on the seventh insulating fixing block 342.

The plurality of fourth conductive terminals 341 include a seventh signal terminal S7, an eighth signal terminal S8, a seventh ground terminal G7 located on one side of the seventh signal terminal S7 and the eighth signal terminal S8, and an eighth ground terminal G8 located on another side of the seventh signal terminal S7 and the eighth signal terminal S8. Preferably, the seventh signal terminal S7 and the eighth signal terminal S8 in each group of fourth conductive terminals 341 form a differential pair to improve signal transmission speed. The seventh ground terminal G7, the seventh signal terminal S7, the eighth signal terminal S8 and the eighth ground terminal G8 are disposed in sequence along the second direction A2-A2.

In the illustrated embodiment of the present disclosure, each fourth conductive terminal 341 includes a seventh fixing portion 3411 and an eighth fixing portion 3412 bent from the seventh fixing portion 3411. The seventh fixing portion 3411 extends along the first direction A1-A1. The eighth fixing portion 3412 extends along the third direction A3-A3.

Besides, the seventh signal terminal S7 and the eighth signal terminal S8 each include a fourth contact arm 3413 protruding forward beyond the seventh insulating fixing block 342 along the first direction A1-A1. The fourth contact arm 3413 includes a fourth contact portion 3413a protruding into the fourth receiving slot 14a. Neither the seventh signal terminal S7 nor the eighth signal terminal S8 is in contact with the fourth conductive body 14 in order to prevent short circuit. The seventh ground terminal G7 includes a seventh abutting portion 3414 protruding beyond the seventh insulating fixing block 342 along the first direction A1-A1. The eighth ground terminal G8 includes an eighth abutting portion 3415 protruding beyond the seventh insulating fixing block 342. At least one of the seventh abutting portion 3414 and the eighth abutting portion 3415 is in contact with the fourth conductive body 14 to achieve grounding. In the illustrated embodiment of the present disclosure, the seventh abutting portion 3414 and the eighth abutting portion 3415 are both in contact with the fourth conductive body 14 to achieve grounding. The seventh abutting portion 3414 is in elastic contact or inelastic contact with the fourth conductive body 14; and/or the eighth abutting portion 3415 is in elastic contact or inelastic contact with the fourth conductive body 14.

The seventh abutting portion 3414 is located at a free end of the seventh ground terminal G7. The seventh ground terminal G7 is not provided with a fourth contact arm 3413 protruding into the fourth receiving slot 14a. Similarly, the eighth abutting portion 3415 is located at a free end of the eighth ground terminal G8. The eighth ground terminal G8 is not provided with a fourth contact arm 3413 protruding into the fourth receiving slot 14a.

The seventh insulating fixing block 342 is at least partially fixed to the seventh fixing portion 3411 of the seventh signal terminal S7, the seventh fixing portion 3411 of the eighth signal terminal S8, the seventh fixing portion 3411 of the seventh ground terminal G7 and the seventh fixing portion 3411 of the eighth ground terminal G8. The fourth contact arm 3413 of the seventh signal terminal S7 is connected to the seventh fixing portion 3411 of the seventh signal terminal S7. The fourth contact arm 3413 of the eighth signal terminal S8 is connected to the seventh fixing portion 3411 of the eighth signal terminal S8. The seventh abutting portion 3414 of the seventh ground terminal G7 is connected to the seventh fixing portion 3411 of the seventh ground terminal G7. The eighth abutting portion 3415 of the eighth ground terminal G8 is connected to the seventh fixing portion 3411 of the eighth ground terminal G8.

Besides, the fourth terminal module 34 further includes a fourth insulating combination block 346 fixed on the seventh signal terminal S7 and the eighth signal terminal S8. The fourth insulating combination block 346 is installed into the fourth terminal module installation slot 143 from the fourth installation opening 1416.

In the illustrated embodiment of the present disclosure, the fourth insulating combination block 346 and the seventh insulating fixing block 342 are spaced apart along the first direction A1-A1. Moreover, the fourth insulating combination block 346 is disposed closer to the fourth contact portion 3413a than the seventh insulating fixing block 342. Neither the seventh abutting portion 3414 nor the eighth abutting portion 3415 extends beyond the fourth insulating combination block 346.

The seventh ground plate 344 is installed on the seventh insulating fixing block 342. The seventh ground plate 344 includes a thirteenth mating portion 3441 in contact with at least part of the seventh fixing portion 3411 of the seventh ground terminal G7, a fourteenth mating portion 3442 in contact with at least part of the seventh fixing portion 3411 of the eighth ground terminal G8, and a seventh raised portion 3443 connecting the thirteenth mating portion 3441 and the fourteenth mating portion 3442. The seventh raised portion 3443 is not in contact with the seventh fixing portion 3411 of the seventh signal terminal S7 and the seventh fixing portion 3411 of the eighth signal terminal S8 in order to prevent short circuit.

In the illustrated embodiment of the present disclosure, the eighth insulating fixing block 343 is at least partially fixed on the eighth fixing portion 3412 of the seventh signal terminal S7, the eighth fixing portion 3412 of the eighth signal terminal S8, the eighth fixing portion 3412 of the seventh ground terminal G7 and the eighth fixing portion 3412 of the eighth ground terminal G8.

The seventh signal terminal S7 further includes a seventh mounting foot 3416 bent from the eighth fixing portion 3412 of the seventh signal terminal S7. The seventh mounting foot 3416 protrudes beyond the eighth insulating fixing block 343 and is configured to be mounted to the seventh signal conductive pad 2061 of the circuit board 200. The eighth signal terminal S8 further includes an eighth mounting foot 3417 bent from the eighth fixing portion 3412 of the eighth signal terminal S8. The eighth mounting foot 3417 protrudes beyond the eighth insulating fixing block 343 and is configured to be mounted to the eighth signal conductive pad 2062 of the circuit board 200. The seventh ground terminal G7 includes a seventh tail portion 3418 extending from the eighth fixing portion 3412 of the seventh ground terminal G7 and protruding beyond the eighth insulating fixing block 343. The eighth ground terminal G8 includes an eighth tail portion 3419 extending from the eighth fixing portion 3412 of the eighth ground terminal G8 and protruding beyond the eighth insulating fixing block 343. Neither the seventh tail portion 3418 nor the eighth tail portion 3419 is directly mounted to the circuit board 200.

In the illustrated embodiment of the present disclosure, the seventh mounting foot 3416 of the seventh signal terminal S7 is perpendicular to the eighth fixing portion 3412 of the seventh signal terminal S7. The eighth mounting foot 3417 of the eighth signal terminal S8 is perpendicular to the eighth fixing portion 3412 of the eighth signal terminal S8. The seventh tail portion 3418 of the seventh ground terminal G7 extends along the third direction A3-A3. The eighth tail portion 3419 of the eighth ground terminal G8 extends along the third direction A3-A3. In the illustrated embodiment of the present disclosure, the seventh mounting foot 3416 and the eighth mounting foot 3417 both extend forwardly and horizontally to be in contact with the seventh signal conductive pad 2061 and the eighth signal conductive pad 2061 of the circuit board 200, respectively. It is understandable to those skilled in the art that in the illustrated embodiment of the present disclosure, the seventh mounting foot 3416 and the eighth mounting foot 3417 can be soldered or welded to the seventh signal conductive pad 2061 and the eighth signal conductive pad 2062 of the circuit board 200, respectively, by surface mounted technology (SMT).

In the illustrated embodiment of the disclosure, the seventh ground plate 344 is provided to connect all the seventh ground terminals G7 and all the eighth ground terminals G8 in series, which is beneficial to improving the ground shielding effect and improving the quality of signal transmission.

In the illustrated embodiment of the present disclosure, two fourth ground plates 44 are provided and made of metal material. Each fourth ground sheet 44 is generally U-shaped and includes a seventh mounting plate 441, an eighth mounting plate 442 disposed opposite to the seventh mounting plate 441, a fourth connecting plate 443 connecting one side of the seventh mounting plate 441 and one side of the eighth mounting plate 442, and a fourth extension plate 444 extending downwardly and backwardly from another side of the eighth mounting plate 442. The seventh mounting plate 441 defines a plurality of fourth mounting positioning holes 4411 that match the fourth positioning posts 1424. The fourth extension plate 444 is received in a corresponding fourth recess 1418 of the fourth conductive body 14. The fourth extension plate 444 is provided with a plurality of fourth mounting holes 4441 to receive the fourth mounting protrusions 1419.

The fourth connecting plate 443 abuts against and at least partially covers the fourth front surface 240 of the fourth insulating block 24. The fourth connecting plate 443 is located at a front end of the second mating slot 102 along the first direction A1-A1. When the mating module is inserted, the tongue plate may be in contact with the fourth connecting plate 443 first, thereby facilitating the discharge of static electricity. The eighth mounting plate 442 is provided with a plurality of fourth grounding elastic arms 445 spaced apart along the second direction A2-A2. The fourth grounding elastic arms 445 are disposed on two sides of the fourth contact arms 3413 of each group of fourth conductive terminals 341 so as to improve the shielding effect and improve the quality of signal transmission.

In an embodiment of the present disclosure, the fourth positioning post 1424 is fixed to the fourth installation positioning hole 4411, so that the seventh mounting plate 441 is fixed on the eighth upper surface 1421 of the fourth protruding portion 142. In one embodiment of the present disclosure, a dimension of the fourth mounting hole 4441 along the first direction A1-A1 is slightly larger than a dimension of the fourth mounting protrusion 1419 along the first direction A1-A1. Therefore, when the fourth grounding elastic arm 445 is deformed by the first ground contact pad of the mating module, the fourth extension plate 444 can move appropriately in the fourth recess 1418 along the first direction A1-A1.

In an embodiment of the present disclosure, the third conductive body 13 and the fourth conductive body 14 are fixed together. For example, after the third conductive body 13 and the fourth conductive body 14 are assembled, they are fixed together by solder or welding or other methods. The third receiving slot 13a and the fourth receiving slot 14a are in communication with each other to form the second mating slot 102.

Besides, referring to FIG. 10, and FIG. 15 to FIG. 17, in the illustrated embodiment of the present disclosure, the electrical connector 100 further includes a first partition 71 located between the second insulating fixing block 313 and the fourth insulating fixing block 323 along the first direction A1-A1, and a second partition 72 located between the fourth insulating fixing block 323 and the sixth insulating fixing block 333 along the first direction A1-A1. The first partition 71 is clamped between the second insulating fixing block 313 and the fourth insulating fixing block 323 so as to maintain a distance between the first module M1 and the second module M2. The second partition 72 is clamped between the fourth insulating fixing block 323 and the sixth insulating fixing block 333 so as to maintain a distance between the second module M2 and the third module M3.

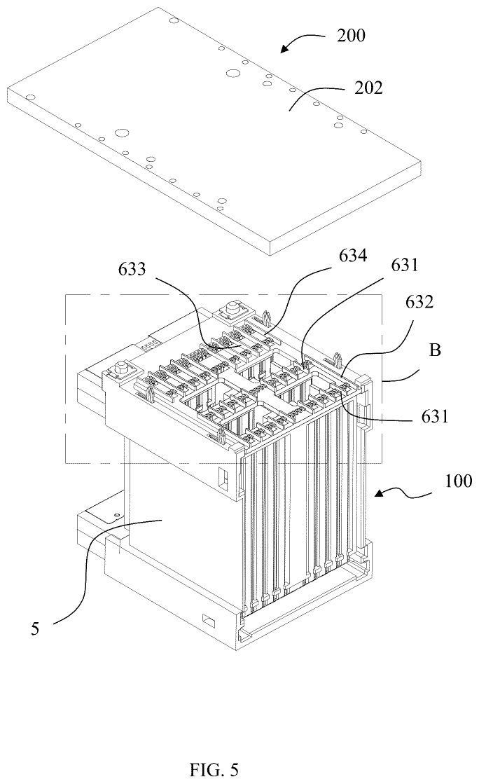

Referring to FIG. 5 to FIG. 7, and FIG. 10 to FIG. 14, in one embodiment of the present disclosure, the conductive mounting block 6 is a metal shell made of metal material to improve the shielding effect and improve the quality of signal transmission. In another embodiment of the present disclosure, the conductive mounting block 6 may also be a composite housing formed by electroplating metal material on an insulating material.

The conductive mounting block 6 includes a main body portion 61, a plurality of protruding blocks protruding from the main body portion 61 and located on one side (for example, an upper side) of the main body portion 61, and a plurality of shielding ribs protruding from the main body portion 61 and located on another side (for example, a lower side) of the main body portion 61. The main body portion 61 includes a first surface 611 (for example, an upper surface) and a second surface 612 (for example, a lower surface) disposed opposite to the first surface 611.

The plurality of protruding blocks include a plurality of first protruding blocks 621 that extend integrally with the main body portion 61 and protrude beyond the first surface 611, and a plurality of second protruding blocks 622 that extend integrally with the main body portion 61 and protrude beyond the first surface 611. The first protruding blocks 621 and the second protruding blocks 622 are located in a first row along the second direction A2-A2 and are arranged in alignment. The first protruding block 621 defines a first insertion hole 6211. The first tail portion 3118 of the first ground terminal G1 is inserted into and fixed in the first insertion hole 6211. The second protruding block 622 defines a second insertion hole 6221. The second tail portion 3119 of the second ground terminal G2 is inserted into and fixed in the second insertion hole 6221. The main body portion 61 further defines a first hollow hole 613 extending through the first surface 611 and the second surface 612. The first hollow hole 613 is located between the first protruding block 621 and the second protruding block 622 along the second direction A2-A2.

The plurality of shielding ribs include a first shielding rib 631 and a second shielding rib 632 which extend integrally with the main body portion 61 and protrude downwardly from the second surface 612 along the third direction A3-A3. The first mounting foot 3116 of the first signal terminal S1 and the second mounting foot 3117 of the second signal terminal S2 pass through the first hollow hole 613 to be located between the first shielding rib 631 and the second shielding rib 632. The first shielding rib 631 is configured to be mounted to the first ground conductive pad 2071 of the circuit board 200, and the second shielding rib 632 is configured to be mounted to the second ground conductive pad 2072 of the circuit board 200. In one embodiment of the present disclosure, the first shielding rib 631 is fixed to the first ground conductive pad 2071 of the circuit board 200 by soldering or welding. The second shielding rib 632 is fixed to the second ground conductive pad 2072 of the circuit board 200 by soldering or welding.

The plurality of protruding blocks include a plurality of third protruding blocks 623 that extend integrally with the main body portion 61 and protrude beyond the first surface 611, and a plurality of fourth protruding blocks 624 that extend integrally with the main body portion 61 and protrude beyond the first surface 611. The third protruding blocks 623 and the fourth protruding blocks 624 are located in a second row along the second direction A2-A2 and are arranged in alignment. The third protruding block 623 defines a third insertion hole 6231. The third tail portion 3218 of the third ground terminal G3 is inserted into and fixed in the third insertion hole 6231. The fourth protruding block 624 defines a fourth insertion hole 6241. The fourth tail portion 3219 of the fourth ground terminal G4 is inserted into and fixed in the fourth insertion hole 6241. The main body portion 61 further includes a second hollow hole 614 extending through the first surface 611 and the second surface 612. The second hollow hole 614 is located between the third protruding block 623 and the fourth protruding block 624 along the second direction A2-A2. The third mounting foot 3216 of the third signal terminal S3 and the fourth mounting foot 3217 of the fourth signal terminal S4 pass through the second hollow hole 614 to be located between the first shielding rib 631 and the second shielding rib 632.

The plurality of protruding blocks include a plurality of fifth protruding blocks 625 that extend integrally with the main body portion 61 and protrude beyond the first surface 611, and a plurality of sixth protruding blocks 626 that extend integrally with the main body portion 61 and protrude beyond the first surface 611. The fifth protruding blocks 625 and the sixth protruding blocks 626 are located in a third row along the second direction A2-A2 and are arranged in alignment. The fifth protruding block 625 defines a fifth insertion hole 6251. The fifth tail portion 3318 of the fifth ground terminal G5 is inserted into and fixed in the fifth insertion hole 6251. The sixth protruding block 626 defines a sixth insertion hole 6261. The sixth tail portion 3319 of the sixth ground terminal G6 is inserted into and fixed in the sixth insertion hole 6261. The main body portion 61 further includes a third hollow hole 615 extending through the first surface 611 and the second surface 612. The third hollow hole 615 is located between the fifth protruding block 625 and the sixth protruding block 626 along the second direction A2-A2.

The plurality of shielding ribs include a plurality of third shielding ribs 633 and a plurality of fourth shielding ribs 634 that extend integrally with the main body portion 61 and protrude downwardly beyond the second surface 612 along the third direction A3-A3. The fifth mounting foot 3316 of the fifth signal terminal S5 and the sixth mounting foot 3317 of the sixth signal terminal S6 pass through the third hollow hole 615 to be located between the third shielding rib 633 and the fourth shielding rib 634. The third shielding rib 633 is configured to be mounted to the third ground conductive pad 2081 of the circuit board 200. The fourth shielding rib 634 is configured to be mounted to the fourth ground conductive pad 2082 of the circuit board 200. In one embodiment of the present disclosure, the third shielding rib 633 is fixed to the third ground conductive pad 2081 of the circuit board 200 by soldering or welding. The fourth shielding rib 634 is fixed to the fourth ground conductive pad 2082 of the circuit board 200 by soldering or welding.

The plurality of protruding blocks include a plurality of seventh protruding blocks 627 that extend integrally with the main body portion 61 and protrude beyond the first surface 611, and a plurality of eighth protruding blocks 628 that extend integrally with the main body portion 61 and protrude beyond the first surface 611. The seventh protruding blocks 627 and the eighth protruding blocks 628 are located in a fourth row along the second direction A2-A2 and are arranged in alignment. The seventh protruding block 627 defines a seventh insertion hole 6271. The seventh tail portion 3418 of the seventh ground terminal G7 is inserted into and fixed in the seventh insertion hole 6271. The eighth protruding block 628 defines an eighth insertion hole 6281. The eighth tail portion 3419 of the eighth ground terminal G8 is inserted into and fixed in the eighth insertion hole 6281. The main body portion 61 further includes a fourth hollow hole 616 extending through the first surface 611 and the second surface 612. The fourth hollow hole 616 is located between the seventh protruding block 627 and the eighth protruding block 628 along the second direction A2-A2. The seventh mounting foot 3416 of the seventh signal terminal S7 and the eighth mounting foot 3417 of the eighth signal terminal S8 pass through the fourth hollow hole 616 to be located between the third shielding rib 633 and the fourth shielding rib 634.

Compared with the prior art, the first module M1 of the present disclosure is provided with the first conductive body 11. Most lengths of the first contact arms 3113 of the first signal terminal S1 and the second signal terminal S2 are located in the first conductive body 11 along the first direction A1-A1. The first conductive body 11 can form a better shielding effect on the first contact arms 3113 of the first signal terminal S1 and the second signal terminal S2. In addition, by providing the first grounding elastic arms 415 on two sides of the first contact arms 3113 of the first signal terminal S1 and the second signal terminal S2, the shielding effect of the mating area is further improved.

In the present disclosure, by providing the first ground plate 314 and the second ground plate 315, the first ground plate 314 and the second ground plate 315 are in contact with the first ground terminal G1 and the second ground terminal G2, respectively. Therefore, a better shielding effect can be provided along the lengths of the first fixing portions 3111 of the first signal terminal S1 and the second signal terminal S2, and along the lengths of the second fixing portions 3112 of the first signal terminal S1 and the second signal terminal S2, thereby improving the shielding effect of these portions.

The present disclosure improves the shielding effect on the first mounting foot 3116 of the first signal terminal S1 and the second mounting foot 3117 of the second signal terminal S2 by providing the conductive mounting block 6. The conductive mounting block 6 having an integral structure in the present disclosure is beneficial to further improving the shielding effect.

In addition, in the present disclosure, by having the first abutting portion 3114 of the first ground terminal G1 and the second abutting portion 3115 of the second ground terminal G2 be in contact with the first conductive body 11, and by having the first tail portion 3118 of the first ground terminal G1 and the second tail portion 3119 of the second ground terminal G2 be connected to the conductive mounting block 6, a better shielding effect can be achieved throughout the lengths of the first signal terminal S1 and the second signal terminal S2, thereby improving the quality of signal transmission.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a first conductive body, the first conductive body defining a first receiving slot extending along a first direction;
a first terminal module, the first terminal module being at least partially mounted to the first conductive body; the first terminal module comprising a plurality of first conductive terminals; the plurality of first conductive terminals comprising a first signal terminal, a second signal terminal, a first ground terminal located on one side of the first signal terminal and the second signal terminal, and a second ground terminal located on another side of the first signal terminal and the second signal terminal; each of the first signal terminal and the second signal terminal comprising a first contact arm; the first contact arm comprising a first contact portion protruding into the first receiving slot; neither the first signal terminal nor the second signal terminal being in contact with the first conductive body; the first signal terminal further comprising a first mounting foot configured to be mounted to a circuit board; the second signal terminal further comprising a second mounting foot configured to be mounted to the circuit board; the first ground terminal comprising a first tail portion; the second ground terminal comprising a second tail portion; and
a conductive mounting block mounted to the first terminal module; the conductive mounting block comprising a first shielding rib, a second shielding rib and a first hollow hole; at least one of the first tail portion of the first ground terminal and the second tail portion of the second ground terminal being electrically connected to the conductive mounting block;
both the first mounting foot of the first signal terminal and the second mounting foot of the second signal terminal passing through the first hollow hole to be located between the first shielding rib and the second shielding rib; the first shielding rib and the second shielding rib being configured to be mounted to the circuit board.

2. The electrical connector according to claim 1, wherein the conductive mounting block defines a first insertion hole and a second insertion hole; the first tail portion of the first ground terminal is inserted into the first insertion hole; the second tail portion of the second ground terminal is inserted into the second insertion hole.

3. The electrical connector according to claim 2, wherein the conductive mounting block comprises a main body portion; the main body portion comprises a first surface and a second surface disposed opposite to the first surface;
the conductive mounting block comprises a first protruding block which extends integrally with the main body portion and protrudes beyond the first surface, and a second protruding block which extends integrally with the main body portion and protrudes beyond the first surface; the first insertion hole is provided on the first protruding block; the second insertion hole is provided on the second protruding block;
the first shielding rib and the second shielding rib extend integrally with the main body portion and protrude beyond the second surface;
the first hollow hole extends through the first surface and the second surface.

4. The electrical connector according to claim 1, wherein the first terminal module comprises a first insulating fixing block at least partially fixed on the first signal terminal, the second signal terminal, the first ground terminal and the second ground terminal;
the first ground terminal comprises a first abutting portion protruding beyond the first insulating fixing block along the first direction; the second ground terminal comprises a second abutting portion protruding beyond the first insulating fixing block along the first direction; the first abutting portion and the second abutting portion are in contact with the first conductive body.

5. The electrical connector according to claim 4, wherein the first abutting portion is in elastic contact or inelastic contact with the first conductive body; and/or
the second abutting portion is in elastic contact or inelastic contact with the first conductive body.

6. The electrical connector according to claim 4, wherein the first abutting portion is located at a free end of the first ground terminal; the first ground terminal is not provided with a first contact arm protruding into the first receiving slot;
the second abutting portion is located at a free end of the second ground terminal; the second ground terminal is not provided with a first contact arm protruding into the first receiving slot.

7. The electrical connector according to claim 4, wherein each first conductive terminal comprises a first fixing portion; the first insulating fixing block is at least partially fixed on the first fixing portion of the first signal terminal, the first fixing portion of the second signal terminal, the first fixing portion of the first ground terminal and the first fixing portion of the second ground terminal;
the first contact arm of the first signal terminal is connected to the first fixing portion of the first signal terminal;
the first contact arm of the second signal terminal is connected to the first fixing portion of the second signal terminal;
the first abutting portion of the first ground terminal is connected to the first fixing portion of the first ground terminal;
the second abutting portion of the second ground terminal is connected to the first fixing portion of the second ground terminal;
the first terminal module further comprises a first insulating combination block fixed on the first signal terminal and the second signal terminal; the first insulating combination block is at least partially installed in the first conductive body.

8. The electrical connector according to claim 7, wherein the first insulating combination block and the first insulating fixing block are spaced apart along the first direction; the first insulating combination block is disposed closer to the first contact portion than the first insulating fixing block;
neither the first abutting portion nor the second abutting portion extends beyond the first insulating combination block.

9. The electrical connector according to claim 7, wherein the first terminal module further comprises a first ground plate mounted to the first insulating fixing block; the first ground plate comprises a first mating portion in contact with at least part of the first fixing portion of the first ground terminal, a second mating portion in contact with at least part of the first fixing portion of the second ground terminal, and a first raised portion connecting the first mating portion and the second mating portion; the first raised portion is not in contact with either the first fixing portion of the first signal terminal or the first fixing portion of the second signal terminal.

10. The electrical connector according to claim 7, wherein each first conductive terminal comprises a second fixing portion bent from the first fixing portion;
the first terminal module further comprises a second insulating fixing block at least partially fixed on the second fixing portion of the first signal terminal, the second fixing portion of the second signal terminal, the second fixing portion of the first ground terminal and the second fixing portion of the second ground terminal;
the first mounting foot of the first signal terminal is bent from the second fixing portion of the first signal terminal; the first mounting foot protrudes beyond the second insulating fixing block and is configured to be mounted on a first signal conductive pad of a circuit board;
the second mounting foot of the second signal terminal is bent from the second fixing portion of the second signal terminal; the second mounting foot protrudes beyond the second insulating fixing block and is configured to be mounted on a second signal conductive pad of the circuit board;
the first tail portion of the first ground terminal extends from the second fixing portion of the first ground terminal and protrudes beyond the second insulating fixing block;
the second tail portion of the second ground terminal extends from the second fixing portion of the second ground terminal and protrudes beyond the second insulating fixing block;
the first tail portion and the second tail portion are not directly mounted to the circuit board.

11. The electrical connector according to claim 10, wherein the first ground terminal, the first signal terminal, the second signal terminal and the second ground terminal are disposed in sequence along a second direction;
the second fixing portion extends along a third direction; each two of the first direction, the second direction and the third direction are perpendicular to each other;
the first mounting foot of the first signal terminal is perpendicular to the second fixing portion of the first signal terminal; the second mounting foot of the second signal terminal is perpendicular to the second fixing portion of the second signal terminal; the first tail portion of the first ground terminal extends along the third direction; the second tail portion of the second ground terminal extends along the third direction.

12. The electrical connector according to claim 10, wherein the first terminal module further comprises a second ground plate mounted to the second insulating fixing block; the second ground plate comprises a third mating portion in contact with at least part of the second fixing portion of the first ground terminal, a fourth mating portion in contact with at least part of the second fixing portion of the second ground terminal, and a second raised portion connecting the third mating portion and the fourth mating portion; the second raised portion is not in contact with either the second fixing portion of the first signal terminal or the second fixing portion of the second signal terminal.

13. The electrical connector according to claim 1, wherein the first terminal module comprises a first insulating block fixed to the first conductive body; the first insulating block defines a first slit and a second slit; the first contact arm of the first signal terminal extends at least partially into the first slit; the first contact arm of the second signal terminal extends at least partially into the second slit.

14. The electrical connector according to claim 1, further comprising:
a second conductive body, the second conductive body defining a second receiving slot extending along the first direction; and
a second terminal module, the second terminal module being at least partially mounted to the second conductive body; the second terminal module comprising a plurality of second conductive terminals; the plurality of second conductive terminals comprising a third signal terminal, a fourth signal terminal, a third ground terminal located on one side of the third signal terminal and the fourth signal terminal, and a fourth ground terminal located on another side of the third signal terminal and the fourth signal terminal; each of the third signal terminal and the fourth signal terminal comprising a second contact arm; the second contact arm comprising a second contact portion protruding into the second receiving slot; neither the third signal terminal nor the fourth signal terminal being in contact with the second conductive body; the third signal terminal further comprising a third mounting foot configured to be mounted on the circuit board; the fourth signal terminal further comprising a fourth mounting foot configured to be mounted on the circuit board; the third ground terminal comprising a third tail portion; the fourth ground terminal comprising a fourth tail portion;
wherein the conductive mounting block defines a second hollow hole; the third tail portion of the third ground terminal and the fourth tail portion of the fourth ground terminal are both electrically connected to the conductive mounting block; the third mounting foot of the third signal terminal and the fourth mounting foot of the fourth signal terminal both pass through the second hollow hole to be located between the first shielding rib and the second shielding rib.

15. The electrical connector according to claim 14, wherein the conductive mounting block defines a third insertion hole and a fourth insertion hole; the third tail portion of the third ground terminal is inserted into the third insertion hole; the fourth tail portion of the fourth ground terminal is inserted into the fourth insertion hole.

16. The electrical connector according to claim 15, wherein the conductive mounting block comprises a main body portion; the main body portion comprises a first surface and a second surface disposed opposite to the first surface;
the conductive mounting block comprises a third protruding block which extends integrally with the main body portion and protrudes beyond the first surface, and a fourth protruding block which extends integrally with the main body portion and protrudes beyond the first surface; the third insertion hole is provided on the third protruding block; the fourth insertion hole is provided on the fourth protruding block;
the first shielding rib and the second shielding rib extend integrally with the main body portion and protrude beyond the second surface;
the second hollow hole extends through the first surface and the second surface.

17. The electrical connector according to claim 14, wherein the second terminal module comprises a third insulating fixing block at least partially fixed on the third signal terminal, the fourth signal terminal, the third ground terminal and the fourth ground terminal;
the third ground terminal comprises a third abutting portion protruding beyond the third insulating fixing block along the first direction; the fourth ground terminal comprises a fourth abutting portion protruding beyond the third insulating fixing block along the first direction; both the third abutting portion and the fourth abutting portion being in contact with the second conductive body;
wherein the first conductive body and the second conductive body are fixed to form a mating slot configured to at least partially receive a mating module; the mating slot comprises the first receiving slot and the second receiving slot.

18. The electrical connector according to claim 17, wherein the third abutting portion is in elastic contact or inelastic contact with the second conductive body; and/or
the fourth abutting portion is in elastic contact or inelastic contact with the second conductive body.

19. The electrical connector according to claim 17, wherein the third abutting portion is located at a free end of the third ground terminal; the third ground terminal is not provided with a second contact arm protruding into the second receiving slot;
the fourth abutting portion is located at a free end of the fourth ground terminal; the fourth ground terminal is not provided with a second contact arm protruding into the second receiving slot.

20. A connector assembly, comprising:
an electrical connector, the electrical connector comprising:
a first conductive body defining a first receiving slot extending along a first direction;
a first terminal module being at least partially mounted to the first conductive body; the first terminal module comprising a plurality of first conductive terminals; the plurality of first conductive terminals comprising a first signal terminal, a second signal terminal, a first ground terminal located on one side of the first signal terminal and the second signal terminal, and a second ground terminal located on another side of the first signal terminal and the second signal terminal; each of the first signal terminal and the second signal terminal comprising a first contact arm; the first contact arm comprising a first contact portion protruding into the first receiving slot; neither the first signal terminal nor the second signal terminal being in contact with the first conductive body; the first signal terminal further comprising a first mounting foot; the second signal terminal further comprising a second mounting foot; the first ground terminal comprising a first tail portion; the second ground terminal comprising a second tail portion; and
a conductive mounting block mounted to the first terminal module; the conductive mounting block comprising a first shielding rib, a second shielding rib and a first hollow hole; at least one of the first tail portion of the first ground terminal and the second tail portion of the second ground terminal being electrically connected to the conductive mounting block; both the first mounting foot of the first signal terminal and the second mounting foot of the second signal terminal passing through the first hollow hole to be located between the first shielding rib and the second shielding rib; and
a circuit board comprising a plurality of first conductive pads, a first ground conductive pad and a second ground conductive pad; the plurality of first conductive pads comprising a first signal conductive pad and a second signal conductive pad; the first signal conductive pad and the second signal conductive pad forming a first signal conductive pad group; the first ground conductive pad and the second ground conductive pad being located on two sides of the first signal conductive pad group, respectively; a length of the first ground conductive pad along the first direction being greater than a length of the first signal conductive pad along the first direction, and being also greater than a length of the second signal conductive pad along the first direction; a length of the second ground conductive pad along the first direction being greater than the length of the first signal conductive pad along the first direction, and being also greater than the length of the second signal conductive pad along the first direction;
wherein the first mounting foot of the first signal terminal is in electrical contact with the first signal conductive pad; the second mounting foot of the second signal terminal is in electrical contact with the second signal conductive pad; the first shielding rib of the conductive mounting block is in electrical contact with the first ground conductive pad; and the second shielding rib of the conductive mounting block is in electrical contact with the second ground conductive pad.
